(19) United States
(12) Patent Application Publication
(10) Pub. No.: US 2003/0174585 A1
(43) Pub. Date: Sep. 18, 2003

(54) Electronic timepiece and method of driving eletronic timepiece

(76) Inventors: Kiyotaka Igarashi, Tokyo (JP); Kenji Shimoda, Tokyo (JP)

Correspondence Address: Smith Gambrell & Russell, Beveridge DeGrandi Weilacher & Young, Intellectual Property Group, 1850 M Street NW Suite 800, Washington, DC, 20036, US

(21) Appl. No.: 10/344,734

(22) PCT Filed: Mar. 23, 2001
(86) PCT No.: PCT/JP01/02365

(30) Foreign Application Priority Data
Aug. 15, 2000 (JP) 2000-246301

(51) Int. Cl. G04B 9/00; G04C 23/00

(52) U.S. Cl. 368/66

(57) ABSTRACT

An electronic timepiece having functions of a function-display operation and a power-saving operation, and driving method of the electronic timepiece. The electronic timepiece has time information generating means for generating time information, function information generating means for generating function information, display means for selectively display time information and function information, power-saving operation means for performing operations in a power-saving operation state consuming a power less than the normal operation state, and power-saving operation preferential means-for making the power-saving operation of power-saving operation means prior to the operation of function information.

### TECHNICAL FIELD

The present invention relates to an electronic timepiece and an electronic timepiece driving method, and more particularly, to an electronic timepiece capable of improving the use value of an electronic timepiece having an additional function and an electronic timepiece driving method.

### BACKGROUND ART

Among recent electronic timepieces, some electronic timepieces are practically used each of which has a built-in mechanism for display a plurality of functions including a chronographic display function, alarm display function, atmosphere display function, depth display function, and temperature display function and is constituted so as to display one or more function information on predetermined display means simultaneously with or instead of time information.

Moreover, among electronic timepieces, some electronic timepieces have been known so far to each of which a power-saving mode function for reducing power consumption is added unless any trouble occurs when operating the electronic timepiece, in order to keep as long as possible the power source means comprising a battery or a condenser in use with a power generating means or the like.

For example, as disclosed in Japanese Patent Publication No. 5-60075, an electronic timepiece using a solar battery as the main power source is known which is constituted so as to reduce power consumption as a power-saving mode when sunlight is not supplied to the solar battery of the electronic timepiece for a predetermined certain period and cancel the power-saving mode when sunlight is supplied to the solar battery again.

The power-saving mode function of this type of the conventional electronic timepiece is constituted so as to set a power-saving mode and stop display time information in a state disadvantageous for a power source, for example, when it gets dark in a case of using a solar battery as a power source.

The above power-saving mode function and a function information operation state mode improve the commodity value of an electronic timepiece. However, because these modes may functionally interfere with each other, it is necessary to adjust driving of operations of the both functions.

### DISCLOSURE OF INVENTION

It is an object of the present invention to provide an electronic timepiece having functions of the function-display operation and power-saving operation and an electronic timepiece driving method, that is, an electronic timepiece having a high commodity value constituted so that it is possible to separately use a power-saving mode function for reducing power consumption and a function information operation state mode for providing a lot of additional function information and an electronic timepiece driving method.

To achieve the above object, the present invention uses the following technical configurations.

A first aspect of an electronic timepiece according to the present invention comprises time information generating means for generating time information, function information generating means for generating function information, display means for making it possible to selectively display the time information and/or function information, power-saving means for performing an operation in a power-saving state consuming a power less than the normal operation state, and power-saving operation preferential means for making the power-saving operation of the power-saving means prior to the function information operation.

The display means of an electronic timepiece operates in two operating states such as a normal operation state and a power-saving state whose power consumptions are different from each other. The normal operation state always displays time information and displays function information when display of the function information is selected. However, the power-saving state stops display of time information to reduce power consumption compared to the case of the normal operation state. In this case, counting the time information is continued so that display of the time information can be resumed when the power-saving state is canceled.

Power-saving operation preferential means of the present invention makes the power-saving operation of power-saving means prior to the function information operation, which stops the function information operation in the power-saving state to reduce power consumption. The function information operation includes an operation for generating function information and an operation for display the generated function information and stops either of the operations or the both operations. In this case, it is also possible to constitute the power-saving operation preferential means so as to continue counting the function information in the case of an age-based function and resume display the function information when the power-saving state is canceled, or to save power consumption by stopping counting of the function information.

Moreover, the present invention is capable of having the following more-minute aspects.

A second aspect of an electronic timepiece according to the present invention comprises reference signal generating means, time information generating means for generating time information in accordance with a reference signal supplied from the reference signal generating means, function information generating means for generating function information, display drive means for outputting a driving signal for display function information and time information, and display means for display function information and time information in accordance with a driving signal supplied from the display drive means, and having a power-saving state consuming a power less than the normal operation state, in which the power-saving state is constituted so as to make the power-saving state prior to the function operation state of the function information generating means. The feature of the second aspect resides in that the power-saving state is made prior to the function operation state of the function information generating means. Therefore, when the power-saving state competes with the function operation state, the power-saving state is preferentially set and the function operating state is stopped.

There are third, fourth and fifth aspects as aspects more minute than the second aspect.

The third aspect of an electronic timepiece according to the present invention comprises reference signal generating means, time information generating means for generating time information in accordance with a reference signal supplied from the reference signal generating means, function information generating means for generating function information, display drive means for outputting a driving signal for display function information and time information, and display means for display function information and time information in accordance with a driving signal supplied from the display drive means and having a power-saving state consuming a power less than the normal operation state, in which the function information generated by the function information generating means is disabled in the power-saving state. The disabled function information includes a disabled operation command and disabled display of the function information.

The feature of the electronic timepiece according to the third aspect resides in that when function information is generated by the function information generating means in the power-saving state, the function information is disabled.

The fourth aspect of an electronic timepiece according to the present invention comprises reference signal generating means, time information generating means for generating time information in accordance with a reference signal supplied from the reference signal generating means, function information generating means for generating function information, display drive means for outputting a driving signal for display function information and time information, and display means for display function information and time information in accordance with a driving signal supplied from the display drive means and having a power-saving state consuming a power less than the normal operation state, in which operation command disabling means for disabling an operation command for commanding the function information generating means to start operations is included and the operation command disabling means maintains the power-saving operation by disabling a operation command generated in the power-saving state.

The feature of the electronic timepiece according to the fourth aspect resides in the operation command disabling means. When an operation command for commanding the function information generating means to start operations is generated in the power-saving state, the operation command is disabled and operations of the function information generating means are stopped so that the power-saving operation is not caused to stop by the start of operations of function information.

The fifth aspect of an electronic timepiece according to the present invention comprises reference signal generating means, time information generating means for generating time information in accordance with a reference signal supplied from the reference signal generating means, function information generating means for generating function information, display drive means for outputting a driving signal for display function information and time information, and display means for display function information and time information in accordance with a driving signal supplied from the display drive means and having a power-saving state consuming a power less than the normal operation state, in which when a condition for satisfying the power-saving state is satisfied while the function information generating means operates,; the power-saving state is set instead of the operational state of the function information generating means so as to stop operations of function information operations of function information include an operation for generating function information and an operation for display the generated function information and either or both of the two operations is or are stopped.

The feature of the electronic timepiece according to the fifth aspect resides in that even while function information operates, the present state is changed to the power-saving state to stop display the function information.

Moreover, an electronic timepiece driving method of the present invention is a driving method provided having the same feature as the electronic timepiece of the present invention described above.

According to a first aspect of an electronic timepiece driving method of the present invention, using an electronic timepiece having a power-saving state consuming a power less than the normal operation state and making it possible to selectively display time information or function information, the power-saving operation is made prior to operations of function information. The operations of function information include an operation for generating function information and an operation for display the generated function information and the power-saving operation is made prior to either or both of the operations.

According to a second aspect of an electronic timepiece driving method of the present invention, using an electronic timepiece comprising reference signal generating means, time information generating means for generating time information in accordance with a reference signal supplied from the reference signal generating means, function information generating means for generating function information, display drive means for outputting a driving signal for display function information and time information, and display means for display function information and time information in accordance with a driving signal supplied from the display drive means and having a power-saving state consuming a power less than the normal operation state, control is performed so as to make the power-saving state prior to the function operation state of the function information generating means.

According to a third aspect of an electronic timepiece driving method of the present invention, using an electronic timepiece comprising reference signal generating means, time information generating means for generating time information in accordance with a reference signal supplied from the reference signal generating means, function information generating means for generating function information, display drive means for outputting a driving signal for display function information and time information, and display means for display function information and time information in accordance with a driving signal supplied from the display drive means and having a power-saving state consuming a power less than the normal operation state, when the function information generating means operates in the power-saving state, control is performed so as to disable operations of the function information operations of the function information include an operation for generating function information and an operation for display the generated function information and either or both of the operations is or are disabled.

According to a fourth aspect of an electronic timepiece driving method of the present invention, using an electronic timepiece comprising reference signal generating means, time information generating means for generating time information in accordance with a reference signal supplied from the reference signal generating means, function information generating means for generating function information, display drive means for outputting a driving signal for display function information and time information, and display means for display function information and time information in accordance with a driving signal supplied from the display drive means and having a power-saving state consuming a power less than the normal operation state, control is performed so as to maintain the power-saving operation by disabling an operation command generated in the power-saving state to command the function information generating means to start operations.

According to a fifth aspect of an electronic timepiece driving method of the present invention, using an electronic timepiece comprising reference signal generating means, time information generating means for generating time information in accordance with a reference signal supplied from the reference signal generating means, function information generating means for generating function information, display drive means for outputting a driving signal for display function information and time information, and display means for display function information and time information in accordance with a driving signal supplied from the display drive means and having a power-saving state consuming a power less than the normal operation state, when a condition for satisfying the power-saving state is satisfied while he function information generating means operates, the power-saving state is set instead of the operating state of the function information generating means and control is performed so as to stop operations of function information operations of function information include an operation for generating function information and an operation for display the generated function information and either or both of the operations is or are stopped.

### BRIEF DESCRIPTION OF DRAWINGS

FIG. 1 is schematic view for explaining means of an electronic timepiece of the present invention and operations of the means;

FIG. 2 is a block diagram showing a configuration example of an electronic timepiece of the present invention;

FIG. 3 is a flowchart for explaining a power-saving operation preferential aspect of the present invention;

FIG. 4 is a flowchart for explaining an operation example of controlling means of a power-saving operation preferential aspect of the present invention;

FIG. 5 is a flowchart for explaining an operation example of controlling means of another power-saving operation preferential aspect of the present invention;

FIG. 6 is a front view showing a configuration example of the appearance of a first configuration of an electronic timepiece of the present invention;

FIG. 7 is a block diagram showing a first configuration example of an electronic timepiece of the present invention;

FIG. 8 is a circuit diagram showing a configuration example of controlling means of a first configuration of an electronic timepiece of the present invention;

FIG. 9 is a circuit diagram showing a configuration example of a chronographic control circuit of a first configuration of an electronic timepiece of the present invention;

FIG. 10 is a front view showing a configuration example of the appearance of a second configuration of an electronic timepiece of the present invention;

FIG. 11 is a block diagram showing a second configuration example of an electronic timepiece of the present invention;

FIG. 12 a block diagram sowing a configuration example of controlling means of a second configuration of an electronic timepiece of the present invention;

FIG. 13 is a circuit diagram showing a configuration example of an alarm control circuit used for the second configuration of an electronic timepiece of the present invention;

FIG. 14 is a block diagram showing a third configuration example of an electronic timepiece of the present invention;

FIG. 15 is a block diagram showing a fourth configuration example of an electronic timepiece of the present invention;

FIG. 16 is a block diagram showing a fifth configuration example of an electronic timepiece of the present invention;

FIG. 17 is a block diagram showing a sixth configuration example of an electronic timepiece of the present invention;

FIG. 18 is a block diagram for explaining an analog configuration and its operations for making a power-saving function prior to time adjustment warning function information and charge warning function information;

FIG. 19 is a flowchart for explaining an analog configuration and its operations for making a power-saving function prior to time adjustment warning function information and charge warning function information;

FIG. 20 is a timing chart for explaining an analog configuration and its operations for making a power-saving function prior to time adjustment warning function information and charge warning function information;

FIG. 21 is a flowchart for explaining operations of an analog configuration for making a power-saving function prior to function states of residual capacity warning function information in addition to time adjustment warning function information and charge warning function information;

FIG. 22 is a flowchart for explaining an operation example of the subroutine 1 in the flowchart in FIG. 21;

FIG. 23 is a flowchart for explaining an operation example of the subroutine 2 in the flowchart in FIG. 21;

FIG. 24 is timing chart for explaining operations of an analog configuration for making a power-saving function prior to function states of residual capacity warning function information in addition to time adjustment warning function information and charge warning function information;

FIG. 25 is a block diagram for explaining a digital configuration and operations for making a power-saving function prior to function information such as time adjustment warning function information, charge warning function information, and residual capacity warning function information;

FIG. 26 is a flowchart for explaining a digital configuration and operations for making a power-saving function prior to function information such as time adjustment warning function information, charge warning function information, and residual capacity warning function information;

FIG. 27 is a configuration for explaining a power-saving preferential aspect;

FIG. 28 is a configuration for explaining a power-saving preferential aspect;

FIG. 29 is a configuration for explaining a power-saving preferential aspect;

FIG. 30 is a schematic block diagram for explaining a configuration example for making a power-saving operation prior to an alarm function;

FIG. 31 is a flowchart for explaining an operation example of a power-saving operation prior to an alarm function;

FIG. 32 is a flowchart of a subroutine relating to an alarm notification in the flowchart in FIG. 31;

FIG. 33 is a flowchart for explaining an operation example operations when function information generating means is an alarm function;

FIG. 34 is timing chart-for explaining an operation example when function information generating means is an alarm function;

FIG. 35 is a schematic block diagram for explaining a first aspect of a radio wave correcting timepiece having a power generating function; and

FIG. 36 is a schematic block diagram for explaining a second aspect of a radio wave correcting timepiece having a power generating function.

### BEST MODE OF CARRYING OUT THE INVENTION

Because an electronic timepiece of the present invention uses the above technical configurations, either of a power-saving state and a function operation state is adopted in accordance with the priority of the power-saving state and function operation state when the power-saving state and the function operation state of display means compete with each other or when there is a circuit portion common to a power-saving circuit and a function operation circuit. Specifically, the present invention is constituted so as to make a power-saving state prior to a function operation state. Therefore, when a power-saving state completes with a function operation state, the power-saving state is adopted and the function operation state is canceled.

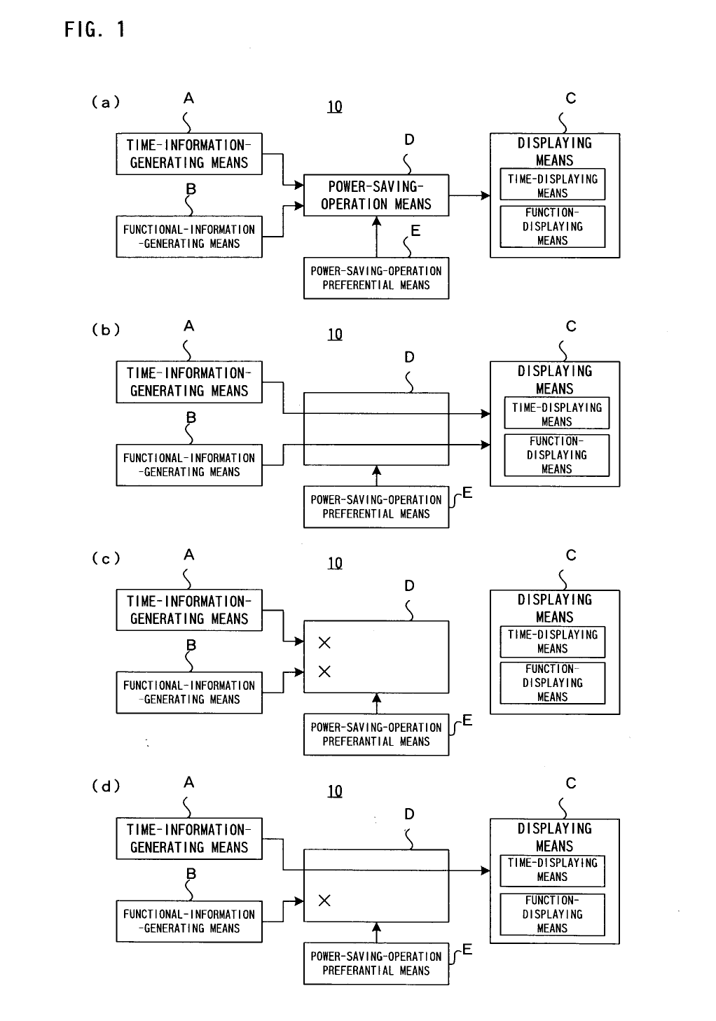

FIG. 1 is schematic view for explaining various means of an electronic timepiece of the present invention and their operations. In FIG. 1(a), an electronic timepiece 10 comprises time information generating means A for generating time information, function information generating means B for generating function information, display means C for making it possible to selectively display the time information and function information, power-saving means D for performing operations in a power-saving state consuming a power less than the normal operation state, and power-saving operation preferential means E for making the power-saving operation of the power-saving means D prior to the function information display operation.

In the normal operation state, as shown in FIG. 1(b), the power-saving means D does not function but the display means C always displays time information and displays function information when selected.

However, in the power-saving state, the power-saving means D makes the power-saving operation prior to the function information display operation in accordance with the preferential operation of the power-saving operation preferential means E and stops display the time information and function information as shown in FIG. 1(c). However, depending on the power-saving state, it is possible to display the time information and stop display the function information as shown in FIG. 1(d).

Moreover, in the case of the operation for stopping display the time information and/or function information, it is possible to continue counting the time information or function information.

That is, in the case of the present invention, a battery-consuming period is increased as long as possible by basically driving components which can be power-saved of an electronic timepiece in the power-saving mode. Moreover, when using various additional functions in order to improve the commodity value of an electronic timepiece, the power-saving state serving as a power-saving mode is made prior to the function display state and when the function display state is executed and a signal for starting the power-saving mode is generated, the power-saving state is made prior so as to stop at least display functions.

In the case of portions to be brought into the power-saving state, there are some portions which must be brought into the power-saving state or function display state depending on an environment such as an electric-timepiece operating state or electric-timepiece operating purpose. All or some of hour, minute, and second hands, display means of a liquid crystal display unit, and relevant circuit portions for controlling them are portions to be power-saved.

Circuit portions include driver circuits of various display means and the power-saving state can be set by stopping operations of the driver circuits. All or some of display means can be used for the present invention and display means relating to the function display state can be also used for the present invention. Moreover, it is possible to constitute display means not relating to the function display state so as to start the power-saving mode independently of presence or absence of the function display state, for example, when the power-generation capacity of power generating means is deteriorated. However, when the power generating capacity of the power generating means is not deteriorated, it is a matter of course that the display means are constituted so as to become the normal operation state.

A configuration example of an electronic timepiece and an electronic timepiece driving method of the present invention is described below in detail by referring to the accompanying drawings.

In the description of the following configuration, an example is described in which display means (hour, minute, and second hands, function hand, or liquid crystal display) is used as one realizing the power-saving state or the function operation state. This display means is only one example of configurations of the present invention. It is not needless to say that a circuit portion directly or indirectly relating to the display means can be naturally included in the range of the present invention as long as the portion can realize the power-saving state or function operation state.

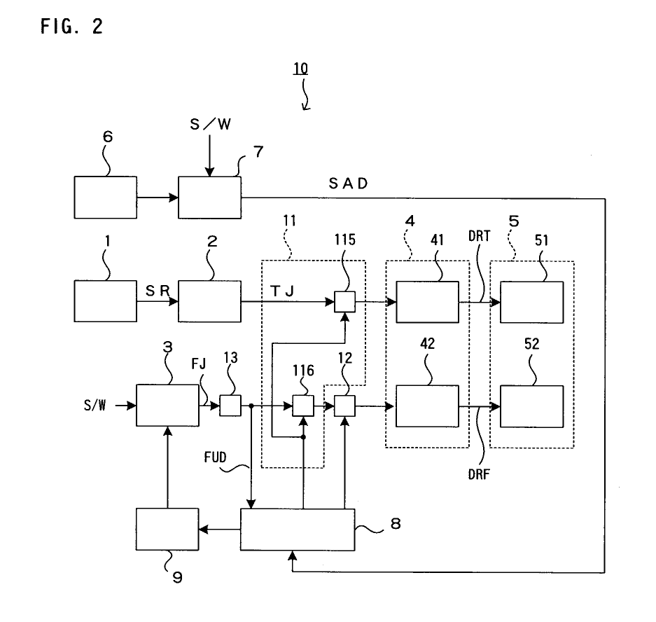

FIG. 2 is a schematic block diagram for explaining a configuration example of the electronic timepiece 10 of the present invention.

The electronic timepiece 10 comprises reference signal generating means 1, time information generating means 2 for generating time information TJ in accordance with a reference signal SR supplied from the reference signal generating means 1, function information generating means 3 for generating function information FJ, display drive means 4 for outputting driving signals DRF and DRT for display the function information FT and time information TJ on a proper display means, and display means 5 for display the function information FJ and time information TJ in accordance with the driving signals DRF and DRT supplied from the display drive means 4.

Moreover, the electronic timepiece 10 comprises power-saving state detecting means 7 and controlling means 8 for making the power-saving state of the time information generating means 2 or the function information generating means 3 prior to the function operation state.

More specifically, a configuration for giving priority to the power-saving state of the electronic timepiece 10 in FIG. 2 includes power-saving state setting means 11, function operation state setting means 12, and controlling means 8.

The power-saving state setting means 11 is means for setting either or both of at least some display means such as time information display means 51 and function information display means 52 to the power-saving state in response to a detection signal SAD of the power-saving state detecting means 7. The function operation state setting means 12 is means for setting at least the function information display means 52 to the function operation state in response to a detection signal FUD of the function operation state detecting means 13.

The controlling means 8 is means for performing control so as to make the power-saving state of the time information display means 51 prior to the function operation state of the function information display means 52 when the power-saving state detecting signal SAD (power saving SAD) completes with the function operation state detecting signal FUD. In FIG. 2, symbol 115 denotes power-saving state setting means for time display means and 116 denotes power-saving state setting means for function information display means.

Controlling means 8 can be operated as operation command disabling means for disabling an operation command for commanding function information generating means to start operations. When the controlling means 8 detects a signal (operation command) from an S/W or the like for commanding the function information generating means 3 to start operations while receiving a power-saving state detecting signal SAD (power saving SAD), it sends an operation command disabling signal FUS to the function operation state setting means 12 to disable an operation command.

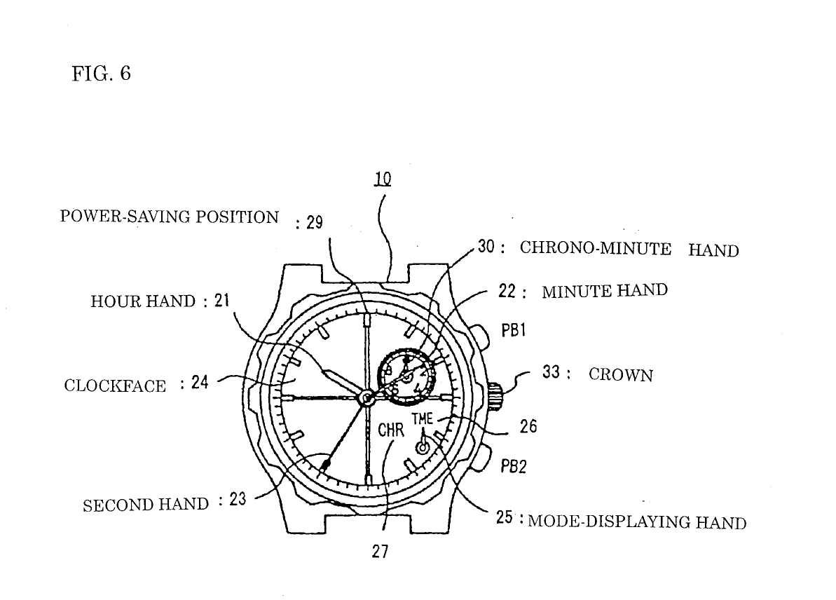

In the case of the above configuration, the time information display means 51 and function information display means 52 may be constituted by circuits separate from each other or a part or the whole of the means 51 and 52 may be overlapped. For example, when chronographic display is performed by the function information display means 52, the second hand 23 of the time information display means 51 (refer to FIG. 6 to be described later) in the normal operation state may be used also as means for display a chronographic second.

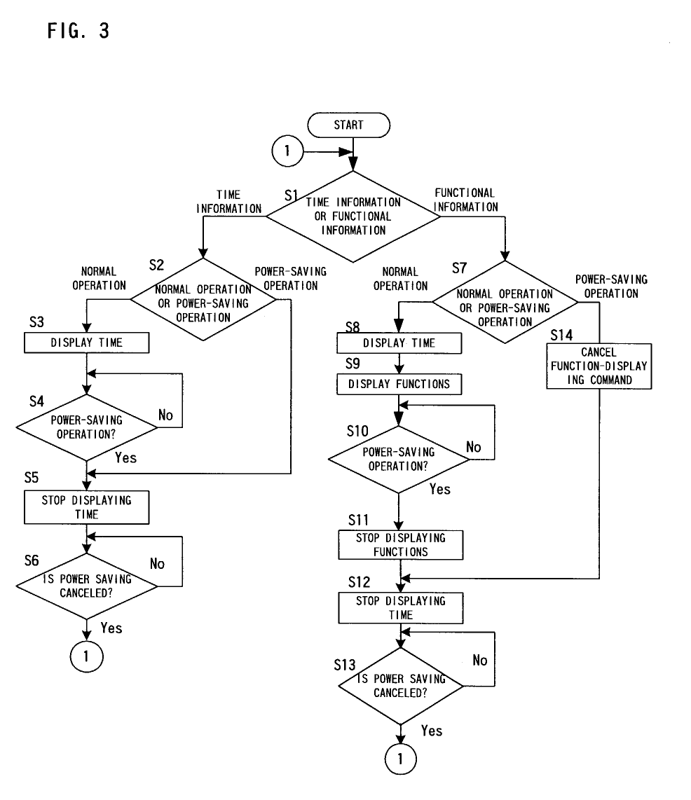

The power-saving operation preferential aspect of the present invention can be realized by a plurality of types of aspects. FIG. 3 is a flowchart for explaining a power-saving operation preferential aspect of the present invention.

An electronic timepiece of the present invention displays time information (step S3) in the normal operation state (step S2) while only time information is displayed but function information is not displayed (step S1) but it stops display time (step S5) when the above state changes to a power-saving operation state (step S4). Moreover, while the power-saving operation state is set in step S2, the electronic timepiece stops display time in step S5. When the power-saving operation is canceled in the above power-saving operation state (step S6), step S1 is restarted.

However, while function information is selected and function information is displayed together with time information (step S1), the electronic timepiece displays the time information (step S8) in the normal operation state (step S7) and moreover displays the function information (step S9) and stops display the function information and time (steps S11 and S12) when the above state changes to the power-saving operation state (step S10).

While the power-saving operation state is set in step S7, the electronic timepiece cancels a function display command (step S14) and stops display time in step S12. When the power-saving operation is canceled in the above power-saving operation state (step S13), step S1 is restarted.

Moreover, instead of the above operating aspect, when the function information generating means 3 operates in the power-saving operation state in the electronic timepiece 10, it is possible to use an aspect for constituting a control system so as to cancel a function operation state. Furthermore, as still another aspect, it is possible to use an aspect for constituting a control system so as to set both or either of the display means 51 and 52 to a power-saving operation state when a condition for starting the power-saving operation state is satisfied while the function information generating means 3 operates in the electronic timepiece 10 having the above configuration in FIG. 2.

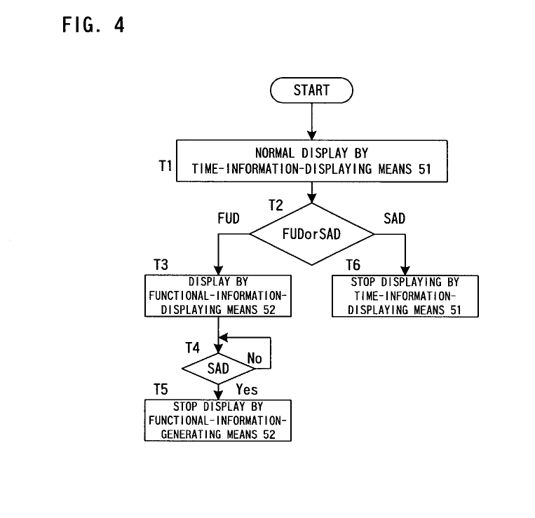

Furthermore, in the case of still another power-saving operation preferential aspect, operations of controlling means are described by referring to the flowchart in FIG. 4.

When the display means 5, particularly the time information display means 51 is in the normal state of display time information (step T1), the controlling means 8 of the electronic timepiece 10 functionly operates the function information display means 52 (step T3) in accordance with the output signal FUD of the function operation state detecting means 13, and sets the time information display means 51 to the power-saving operation state and stops display time in accordance with the output signal SAD of the power-saving state detecting means 7 (step T2) (step T6).

Moreover, when the output signal SAD of the power-saving state detecting means 7 is input (step T4) while functions of the function information display means 52 are displayed in step T3, it is possible to realize a configuration so as to give priority to the output signal SAD and stop display functions of the function information display means 52.

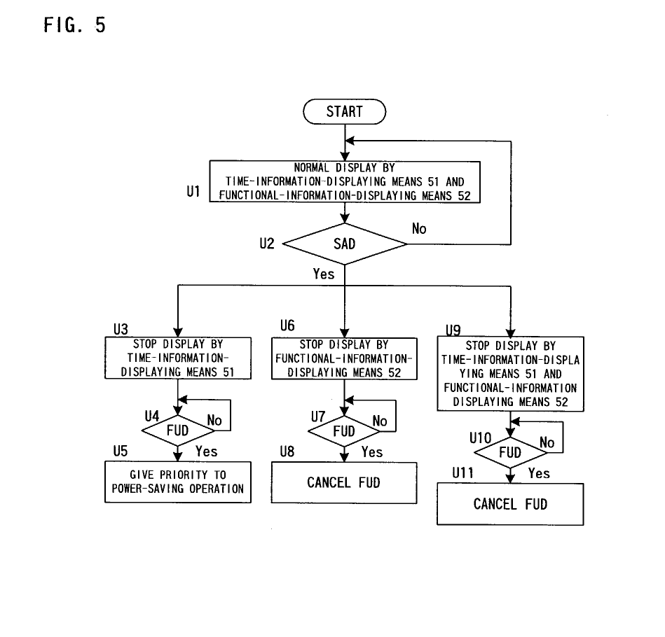

Furthermore, in the case of still another power-saving operation preferential aspect, operations of controlling means are described below by referring to the flowchart in FIG. 5.

When the display means 5 is in the normal operation state (step U1), the controlling means 8 can be constituted as an aspect for performing control so as to set the time information display means 51 and/or function information display means 52 to the power-saving operation state or only the function information display means 52 to the function operation state in response to the output signal FUD of the function operation state detecting means 13 or the output signal SAD of the power-saving state detecting means 7.

When the both display means 5 are in the power-saving operation state (step U2), the electronic timepiece 8 stops display the time information display means 51 (step U3), stops display the function information display means 52 (step U6), or stops display the time information display means 51 and function information display means 52 (step U9). In each state, the electronic timepiece 8 performs an operation for giving priority to the power-saving operation (step U5) when the output signal FUD is supplied from the function operation state detecting means 13 (steps U4, U7, and U10) and display the time information display means 51 is stopped and cancels the function operation command (steps U8 and U11) when display the function information display means 52 is stopped or display the time information display means 51 and function information display means 52 are stopped.

Then, an aspect for setting which display means to the power-saving operation state when the function operation state competes with the power-saving operation state is described below.

In the case of the present invention, it is also possible to constitute the time information display means 51 and function information display means 52 so that the means 51 and 52 are partly overlapped. For example, it is possible to form a second hand as a display member common to the time information display means 51 and function information display means 52.

In the case of the above configuration, it is possible to use an aspect for stopping display the time information display means 51 and function information display means 52 in the power-saving operation state and a power-saving state aspect for display time by the hour hand 21 and minute hand 22 of the time information display means 51 (refer to FIG. 6 to be described later) and stopping display only the second hand 23 of the function information display means 52. In the case of the above aspects, it is possible to use an aspect for stopping operations of a display member (e.g. second hand 23) common to the both display means and an aspect for not stopping the operations.

Moreover, when the function operation state occurs in the power-saving operation state in order of occurrence of the power-saving operation state and function operation state, the power-saving operation state of the display means under the power-saving operation is maintained and a command for a function operation is canceled. However, when the power-saving operation state occurs in the function operation state, display means under the function operation is changed to the power-saving operation state.

Moreover, in the case of all predetermined display means to be stopped in the power-saving operation state, when function information display means becomes the function operation state, it is possible to maintain the power-saving operation state without canceling the power-saving operation state of the display means which are in the power-saving operation state.

Furthermore, the time information display means 51 and function information display means 52 can be used as a plurality of display modes. In the case of the electronic timepiece 10 of the present invention, it is allowed that at least either of the time information display means 51 and function information display means 52 is constituted by a digital display system or analog display system and it is preferable to use an analog display circuit configuration or digital display circuit configuration for other circuit configurations according thereto.

Furthermore, it is allowed that the display means 5 of the present invention is separately constituted like the time information display means 51 and function information display means 52 or a part of or the whole of the both means is constituted so as to be overlapped. For example, when the electronic timepiece 10 uses an analog display system, it is possible that a second hand is constituted so as to display the both informations. Furthermore, when a function is an alarm function, it is possible to use an aspect for display an alarm setting time by the hour hand 21 and minute hand 22 and on/off of an alarm by the second hand 23.

Furthermore, the configuration of power source means used for the electronic timepiece 10 of the present invention is not restricted. It is allowed to use power source means using power generating means including a primary battery such as a normal button battery or a rechargeable secondary battery or including a solar battery, self-winding generator, or temperature-difference generator.

For example, when a power generating environment or charged capacity is deteriorated, by operating the function information display function, it is possible to solve the problem that a battery is exhausted by the power for display function information and the original time display function of an electronic timepiece may stop by giving priority to a power-saving operation state.

Moreover, there are some preferable examples which respectively use power source means in which power generating means and a storage battery are combined.

The power-saving state detecting means 7 used for the present invention determines the present state of the power source means 6 in FIG. 2 constituted by a battery or power generating means and outputs the information serving as a criterion on whether to set the electronic timepiece 10 to the power-saving operation state of greatly decreasing the power consumption of the display drive means 4, display means 5, or other circuit portion of the electronic timepiece 10 compared to the power consumption in the normal operation state, that is, the power-saving state detecting signal SAD.

According to the determination on the state of the above power source means 6, it is allowed that the power source means 6 is constituted so as to automatically output the power-saving state detecting signal SAD (power-saving SAD) by automatically detecting a state in which the residual capacity of a battery in the power source means 6 is lowered to a predetermined threshold value or less, in which the output voltage or output current of the battery is lowered to a predetermined threshold value or less, in which the power generation capacity of the power generating means is lowered to a predetermined threshold value or less or in which the quantity of the light such as sunlight continuously entering a solar battery for a predetermined period when power generating means uses a solar generator is lower than the predetermined value. Moreover, it is allowed to constitute the power source means 6 so as to output the power-saving state detecting signal SAD (power-saving SAD) by detecting that a user manually operates a predetermined button or crown.

When a user manually sets a power-saving operation state, a case is considered in which when some of a plurality of electronic timepieces are not used for a while, the timepieces are manually set to a power-saving operation state.

When at least some of display drive means 4 and at least some of display means 5 of an electronic timepiece of the present invention are kept in a power-saving operation state, control is performed that display information is darkly displayed or deleted in at least some of display means and operations of a display portion are stopped. Even in this case, the time information of the electronic timepiece 10 normally operates and is always stored in predetermined storage means and updated. When the power-saving operation state is canceled, the present time information can be immediately displayed on, for example, the time information display means 51.

Moreover, in the case of the electronic timepiece 10 of the present invention, it is possible that a condition opposite to the condition for generating the above-described power-saving state detecting signal SAD (power-saving SAD) is detected as a condition for canceling the set of power-saving operation state.

The function information used for the electronic timepiece 10 of the present invention includes an alarm function, chronographic function, display function, depth information display function, atmospheric pressure information display function, altitude information display function, temperature-information display function, and water-temperature-information display function. The electronic timepiece uses functions for realizing the above function information as additional functions and includes at least one of these additional functions in a group of additional functions.

In the case of the present invention, when a user of the electronic timepiece 10 wants to use the above additional functions, the user selects the function information generating means 3 corresponding to a desired additional function out of a group of additional functions by manually operating a predetermined button or crown. Thereby, the function operation state detecting signal FUD is output from the function operation state detecting means 13.

As described above, each function of the electronic timepiece of the present invention, particularly a preferential function for making the power-saving operation prior to a function operation and driving an electronic timepiece using the preferential function can be realized by executing the above various means in accordance with a digital configuration including a CPU and a memory and software and moreover, it is also possible to constitute them by hardware.

An electronic timepiece and an electronic timepiece driving method of the present invention are described below by referring to FIGS. 6 to 13 showing a detailed configuration realized by hardware.

This configuration uses the electronic timepiece 10 having the configuration shown in FIG. 6 as an example. The electronic timepiece 10 has a clockface 24 for display normal time information, an hour hand 21, a minute hand 22, and a second hand 23 and moreover has a chronographic display minute hand 30. In the case of this example, the second hand 23 also serves as a chronographic display second hand.

Moreover, this configuration is provided with a mode display hand 25 so that a different function is set depending on the position of the mode display hand 25. In the case of this configuration, the mode display hand 25 is constituted so that it can be changed to two different positions such as a time information display position (TME) 26 for display normal time information and a chronographic display position (CHR) 27 for executing a chronographic display function and it is possible to move the hand 25 to either of the TME 26 or CHR 27 by operating a crown 33.

That is, in the case of this embodiment, by setting the mode display hand 25 to the time information display position (TME) 26, the hour hand 21, minute hand 22, and second hand 23 respectively display the present time while by setting the mode display hand 25 to the chronographic display position (CHR) 27, the hour hand 21 and minute hand 22 display the hour and minute of the present time, the chronographic display function is started with the setting point of time, the second hand 23 displays a chronographic second and shows chronographic elapse of time together with the chronographic minute hand 30.

While the mode display hand 25 is set to the time information display position (TME) 26 or chronographic display position (CHR) 27, when a condition required to start a power-saving operation state is detected, a button PB1 or PB2 is pressed automatically or by a user at this point of time and thereby, the second hand 23 moves to a power-saving position 29 (e.g. position of 0 sec) and displays that the electronic timepiece 10 is set to the power-saving operation state.

Moreover, the power-saving operation state can be canceled automatically in accordance with a detecting signal for detecting that the condition necessary for the power-saving operation state is not satisfied or by manually pressing the specific button PB1 or PB2 provided for the electronic timepiece.

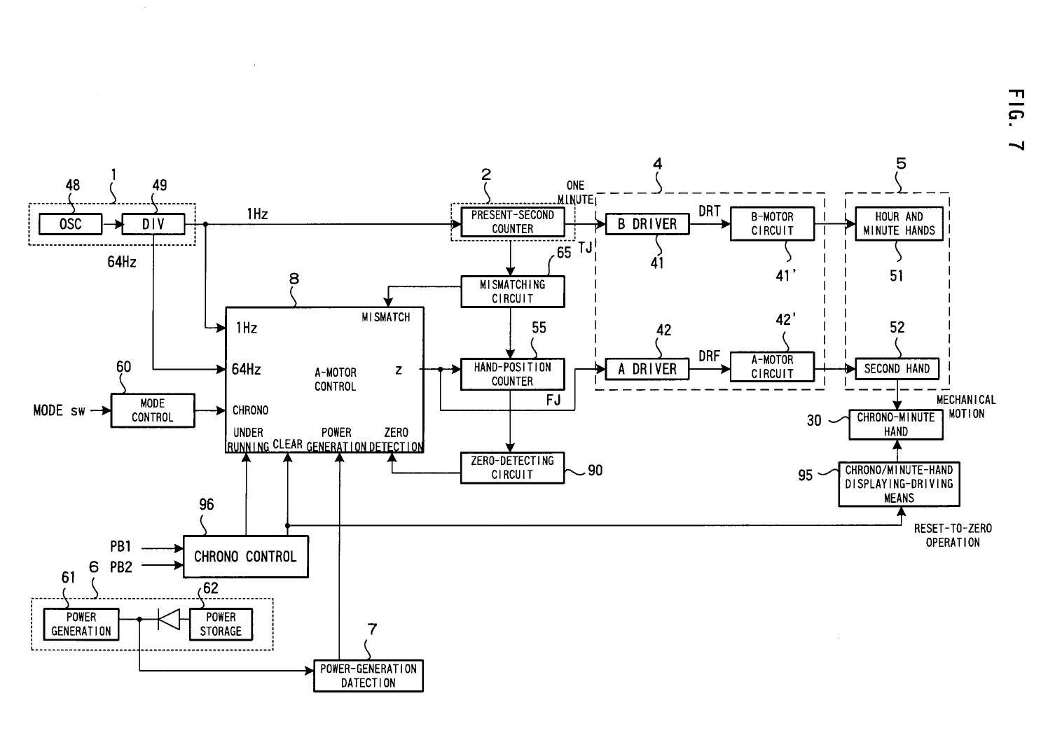

Then, a detailed circuit configuration of the electronic timepiece 10 shown in FIG. 6 is described below by referring to FIGS. 7 to 9.

FIG. 7 is a circuit configuration example of the electronic timepiece 10 to be driven by an analog system, which is shown by a block diagram showing a configuration example when using a chronographic function as additional-function means. The time information display means 51 represented by the hour hand 21 and minute hand 22 and the time information display means 52 represented by the second hand 23 are used as the time information display means 5 and the second hand 23 is constituted so as to also serve as the function information display means 52 for display a chronographic function. Moreover, the chronographic minute hand 30 for display a chronographic function is constituted to be mechanically interlocked with the second hand 23 so as to be driven by chronographic minute hand-display drive means 95. The chronographic minute hand 30 can be adjusted to the zero position in accordance with the mechanical reset-to-zero operation according to a control signal supplied from chronographic display function controlling means 96.

As shown in FIG. 7, this configuration is provided with reference signal generating means 1, time information generating means 2, controlling means 8, display drive means 4, display means 5, and controlling means 8.

The reference signal generating means 1 is constituted by an oscillation circuit 48 and frequency dividing circuit 49. The time information generating means 2 includes proper present second-counting means for receiving a reference signal SR of 1 Hz output from the frequency dividing circuit 49 and generating time information TJ. The driving means 4 includes driver circuits 41 and 42 for outputting driving signals DRT and DRF for display the function information FJ and time information TJ on the proper display means 5 and motor circuits 41′ and 42′ for driving the display means 51 and 52. The display means 5 is constituted by the time information display means 51 for display the function information FJ and time information TJ in accordance with the display drive means 4 and the display means 52 also serving as time information display means and function information display means.

The controlling means 8 includes chronographic function display circuit 82 to be described later for generating the function information FJ such as chronographic function information, and further the controlling means 8 includes power-saving operation preferential means 83 to which a mode selecting information signal, power-saving state detecting signal, and function operation state detecting signal are input to make a power-saving operation-display state prior to a function information display state by a predetermined algorithm.

Moreover, the controlling means 8 is constituted so that signals are input from a mode controlling circuit 60 for forming a mode signal in accordance with the position of the mode display hand 25 set by operating the crown 33, chronographic display function controlling means 96 to be operated in accordance with a signal supplied from the mode controlling circuit 60, power source means 6 constituted by power generating means 61 and a storage battery 62, power-saving state detecting means 7 for detecting an output voltage or output current of the power generating means 61 to determine whether the power generating means 6 is in a state which requires the power-saving operation state of the display means 5, a zero detecting circuit 90 for moving the second hand 23 to the zero-hour position which is a power-saving position while executing the power-saving operation state, a hand position counter 55 for confirming the position of the second hand 23 and a mismatch detecting circuit 65 for detecting the mismatch between a counter value of the present second hand position counter of the time information generating means 2 and a counter value of the hand position counter 55.

Moreover, the controlling means 8 of this configuration is constituted so as to receive 1 Hz signal used to drive hour and minute hands under the normal operation state, a 64 Hz signal used to quickly advance the hour and minute hands from the reference signal generating means 1, a mode selecting information signal output from the mode controlling circuit 60, a power-saving operation state detecting signal output from the power-saving state detecting means 7, a signal relating to an additional-function using state, and for example, when a chronographic function is used, a chronographic function signal RUN, the information on a clear signal CR, and an output of the zero detecting circuit 90 according to necessity.

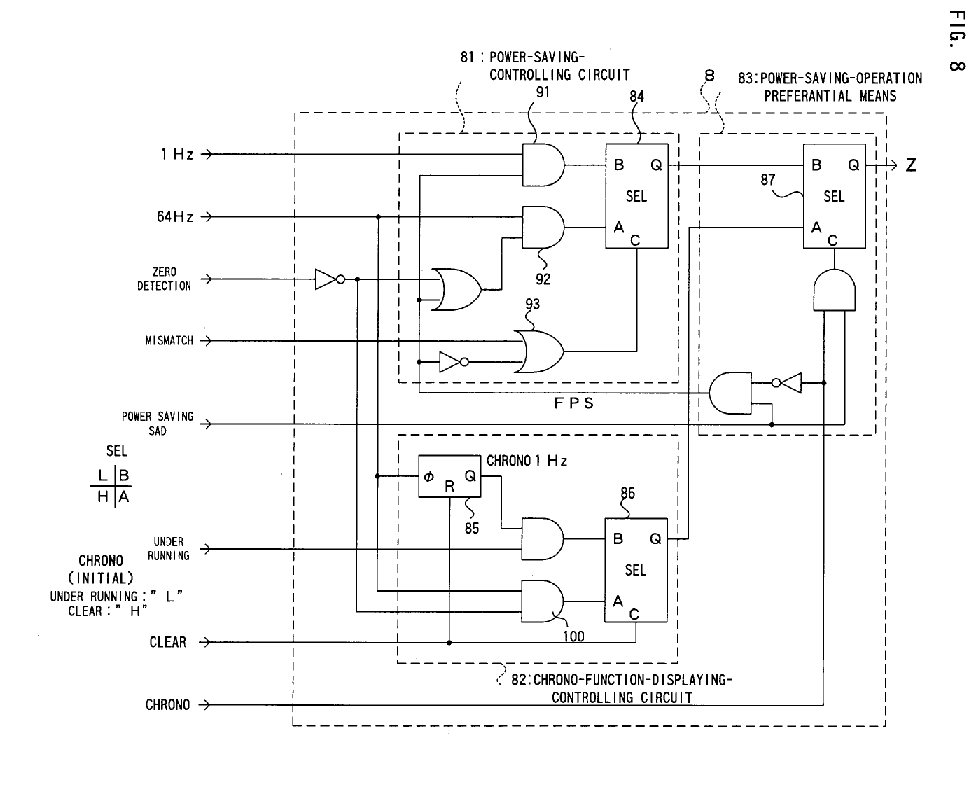

FIG. 8 is a block diagram showing a more specific configuration of the controlling means 8 used for this configuration. The block diagram in FIG. 8 shows a controlling circuit portion for controlling the display drive means 4 (driver circuit 42 and motor circuit 42′) for driving the display means 52 corresponding to the second hand 23 in the controlling means 8. A controlling circuit portion for controlling operations of display means 51 corresponding to the hour hand 21 and minute hand 22 can be constituted almost similarly to the above controlling circuit portion.

As shown in FIG. 8, the controlling means 8 includes a power-saving controlling circuit 81, a zero detecting circuit (in this case, a chronographic zero detecting circuit 82), and a power-saving operation preferentially controlling circuit 83.

In this case, the power-saving controlling circuit 81 receives 1- and 64 Hz pulse signals, an output signal of the zero detecting circuit 90, an output signal of the mismatching circuit 65, and a power-saving operation preferentially controlling signal FPS to be output from a power-saving operation preferentially controlling circuit 83 to be described later. Moreover, the chronographic zero detecting circuit 82 receives a 64 Hz pulse signal, an output signal of the zero detecting circuit 90, a signal while a chronographic display function runs, and a chronographic display function clearing signal.

Moreover, the power-saving operation preferentially controlling circuit 83 is constituted so as to receive a power-saving operation state detecting signal SAD (power-saving SAD) for detecting that a condition of a power-saving operation state is satisfied, a function operation state detecting signal showing a chronographic display function operation state, a signal output from the power-saving controlling circuit 81, and a signal output from the chronographic zero detecting circuit 82.

In the above controlling circuit operations, the normal operation state, power-saving operation state, and power-saving operation-cancel state are described below.

In the case of the normal operation state, a selector 84 of the power-saving controlling circuit 81 is constituted so as to output a signal of an input terminal B from an output terminal Q. Moreover, because no additional function is operated in the power-saving operation preferentially controlling circuit 83, a selector 87 of the power-saving operation preferentially controlling circuit 83 is constituted so as to output a signal of the computer terminal B from the output terminal Q. Thereby, a 1 Hz pulse signal is output to the display drive means 4 as an output Z of the power-saving controlling circuit 81. The second hand 23 is driven in accordance with the 1 Hz pulse signal to display the normal time information.

In the above operations, because the power-saving operation preferentially controlling signal FPS input to the power-saving controlling circuit 81 becomes “H” level in accordance with the logical sum of the power-saving operation state detecting signal SAD (power-saving SAD) (“H” level) and a signal (“H” level) obtained by inverting a function operation state detecting signal showing the operation state of the chronographic display function, an AND circuit 91 directly passes the input 1 Hz pulse signal and the signal is applied to the selector 84. Moreover, because the logical-sum signal of the function operation state detecting signal (“L” level) and the power-saving operation state detecting signal SAD (power-saving SAD) (“H” level) is input to a selection terminal C of the power-saving operation preferentially controlling circuit 83, a signal of the input terminal B is selected as an output signal. Moreover, it is allowed to constitute the AND circuit so that the same operation as the above is applied to the hour hand 21 and minute hand 22.

Furthermore, when a power-saving operation state is detected in the case of this embodiment, the power-saving state detecting signal SAD (power-saving SAD) output from the power-saving state detecting means 7 becomes “L” level, the power-saving operation preferentially controlling signal FPS output from the power-saving operation preferentially controlling circuit 83 also becomes “L” level. Therefore, the AND circuit 91 cuts off the input 1 Hz pulse signal.

At the same time, because an output of the zero detecting circuit 90 becomes “L” level, a 64 Hz pulse signal is output from an AND circuit 92 and input to a terminal A of the selector 84. When the second hand 23 is brought to the position of 0 sec, an output of the zero detecting circuit 90 becomes “H” level and the second hand 23 stops.

Then, when the power-saving operation state is canceled, the. power-saving operation detecting signal SAD (power-saving SAD) output from the power-saving operation detecting means 7 becomes “H” level. Therefore, the power-saving operation preferentially controlling signal FPS output from the power-saving operation preferentially controlling circuit 83 also becomes “H” level. At the same time, because the position of the second hand 23 does not match with the content of the hand position counter 55, an “H” level signal is input to the mismatch terminal of the controlling circuit 8 from the mismatch counter 65 and therefore, an “H” level signal is output from an OR circuit 93. Because the selector 84 is constituted so as to output an A-terminal input from an output Q when an “H” level signal is input to the selection terminal C, a 64 Hz pulse signal passes through the selector 84 and output to the output Q from the input terminal B of the selector 87 in the power-saving operation preferentially controlling circuit 83. As a result, the second hand 23 is quickly advanced and moves to the present second position and the power-saving operation state is canceled.

Logics of the selectors 84 and 87 and a selector 86 to be described later of the controlling means 8 in this embodiment are constituted so as to output a signal input to the input terminal B from the output Q when a control signal input to the control terminal C is kept “L” level and a signal input to the input terminal A from the output Q when a control signal input to the control-terminal C is kept “H” level.

Then, a case is described in which a function operation state competes with a power-saving operation state.

First, when the electronic timepiece 10 displays a time in the normal operation state, if the power-saving operation-sate-detecting signal SAD (power-saving SAD) is input to the controlling means 8 from the power-saving operation state detecting means 7, the controlling means 8 quickly advances the electronic timepiece 10 by using a 64 Hz pulse signal until the content of the hand position counter 55 reaches the position of 0 sec, and also quickly advances the second hand 23 by using the 64 Hz pulse signal and moves the second hand 23 to the position of 0 sec.

As a result, either or both of the display drive means of the time information display means and function information display means is or are stopped. Moreover, in the power-saving operation state, it is allowed to constitute the electronic timepiece 10 so as to stop either or both of the time information display means and function information display means or constitute the electronic timepiece 10 so as to stop only the second hand 23 and normally operate the hour hand 21 and minute hand 22.

In the above power-saving operation state, if a case occurs in which a user wants to use a chronographic function, the user operates the crown 33 to drive the mode controlling circuit 60 and moves the mode display hand 25 to the chronographic function position CHR 27. In this case, the second hand 23 is kept intact at the position of 0 sec.

When using the chronographic display function in the normal operation state, the controlling circuit 8 returns the second hand 23 of the electronic timepiece 10 to the position of 0 sec and synchronizes the start of the second hand with the start of the chronographic minute hand 30 by specifying a chronographic display. First, to return the second hand 23 to the position of 0 sec, the mode controlling means 30 is driven by operating the crown 33. Moreover, by moving the mode display hand 25 to the chronographic display position CHR, the chronographic terminal of the controlling means 8 changes from “L” level to “H” level, the selector 87 of the power-saving operation preferentially controlling circuit 83 performs a change so that a signal input to the terminal A is output from the output Q, and because the second hand 23 is not in the position of 0 sec an “L” level signal is generated by the zero detecting circuit and input to the zero detecting terminal of the controlling means 8.

As a result, an AND circuit 100 in the chronographic zero detecting circuit 82 of the controlling circuit 8 is released and a 64 Hz pulse signal passes through the AND circuit 100 and it input to the terminal A of the selector 86. However, because an “H” level signal is input to the clear terminal of the controlling means 8, the selector 86 outputs the 64 Hz pulse signal input to the terminal A from the output Q and thereby, the second hand is quickly advanced up to the position of 0 sec.

Moreover, to return the chronographic display-operation state to the normal operation state, an “L” level signal is input to the chronographic terminal of the controlling means 8 and thereby, the power-saving operation preferentially controlling signal FPS becomes “H” level. Under the above state, it is assumed that the signal SAD output from the power-saving state detecting means 7 is set to “H” level.

Therefore, the mismatch terminal of the controlling means 8 to which a signal output from the mismatching circuit 65 is set to “H” level and as a result, an “H” level signal is output from the OR circuit 93. Therefore, the selector 84 outputs the 64 Hz pulse signal input to the terminal A from the output Q and the pulse signal is input to the terminal B of the selector 87 provided for the power-saving operation preferentially controlling circuit 83.

However, because “L” level is input to the control terminal C of the selector 87, the selector 87 outputs the 64 Hz pulse signal input to the terminal B from the output Q and thereby, the second hand 23 is quickly advanced to the position showing the present second.

In the case of the above configuration, when using the chronographic display function in the state in which the power-saving operation state is operated, the chronographic terminal of the controlling means 8 becomes “H” level and the signal SAD output from the power-saving state detecting means 7 is set to “L” level.

As a result, the power-saving operation preferentially controlling signal FPS output from the power-saving operation preferentially controlling circuit 83 becomes “L” level and the selector 84 is set so as to output an input signal of the terminal A from the output Q. However, because an output of the AND circuit 92 is turned off, the power-saving controlling circuit 81 is completely shut down and no output is generated and the circuit 81 is brought into a power-saving operation state.

However, even in a case in which a power-saving operation state is set when a chronographic function is executed, priority is given to the power-saving operation. That is, when a condition necessary for starting the power-saving operation state is satisfied and the “L” level power-saving signal SAD is output from the power-saving state detecting means 7, the power-saving operation preferentially controlling signal FPS output from the power-saving operation preferentially controlling circuit 83 becomes “L” level. Therefore, the power-saving controlling circuit 81 continues the shut down state.

That is, in any one of the above cases, the power-saving operation state is executed preferentially to the function operation state and display the power-saving operation state is started or maintained.

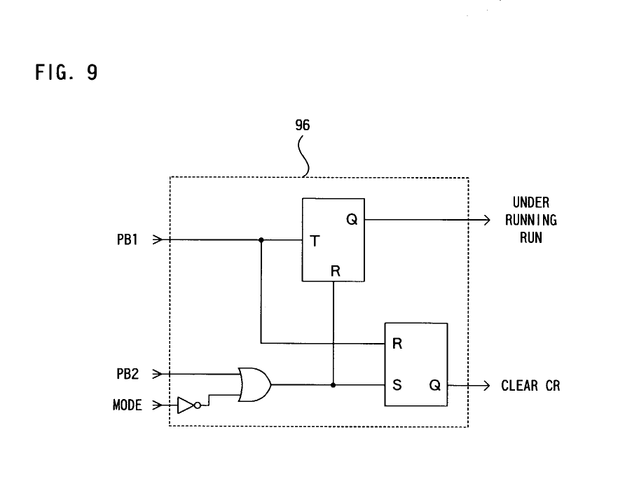

It is possible to use the configuration shown in FIG. 9 as a configuration of the chronographic display function controlling means 96. As shown in FIG. 9, the chronographic display function controlling means 96 is constituted so as to receive output signals from the buttons PB1 and PB2 and a selection signal from the mode selecting means 33 and output a signal RUN showing that a chronographic display function currently runs and a signal CR showing a state in which the chronographic display function is cleared. The signal RUN showing that the chronographic display function currently runs and the signal CR showing the state in which the chronographic display function is cleared are input to the under-running terminal and clear terminal of the controlling circuit 8.

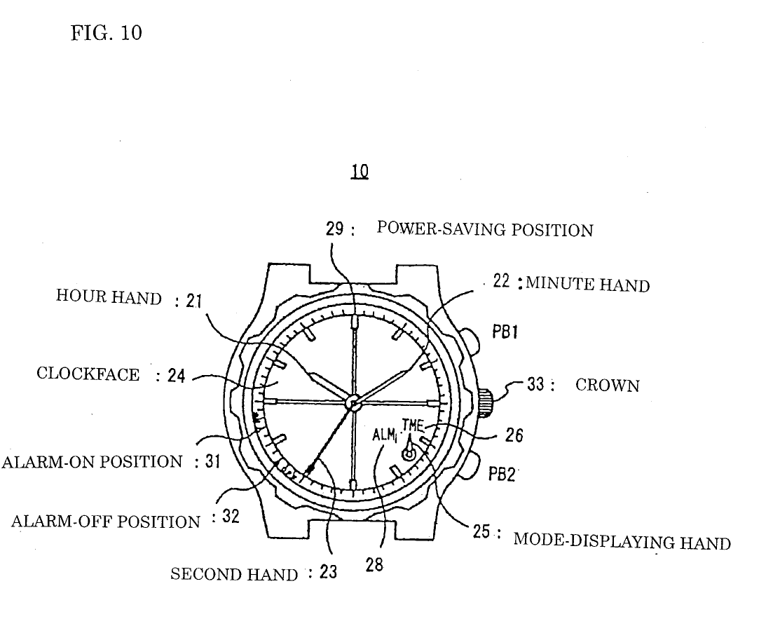

Then, other examples of an electronic timepiece and an electronic timepiece driving method of the present invention are described below by referring to FIGS. 10 to 17. In the case of this embodiment, an electronic timepiece 10 having the configuration shown in FIG. 10 is used as an example, and a component same as that of the electronic timepiece 10 shown in FIG. 6 is provided with the same number and its description is omitted.

In the case of this embodiment, the mode display hand 25 is constituted so as to be changeable to two different positions such as the time information display position (TME) 26 for display the normal time information and an alarm function display position (ALM) 28 for executing an alarm function and can be moved to either of the TME 26 and ALM 28 by operating the crown 33.

In the case of this embodiment, by setting the mode display hand 25 to the alarm function display position (ALM) 28, when an alarm sounding permission is set to the electronic timepiece 10, the second hand 23 moves to an alarm on position 31 such as the 42 sec position of a clockface and stops and moreover displays that an alarm sounding permission is set.

When an alarm sounding inhibition is set to the electronic timepiece 10, the second hand 23 moves to an alarm off position 32, for example, moves to the 38 sec position of the clockface and displays that the alarm sounding inhibition is set. At the same time, because the hour hand 21 and minute hand 22 are quickly advanced to a set alarm time position, a user can know a set alarm time. It is possible to adjust the time of an alarm by drawing and rotating the crown 33.

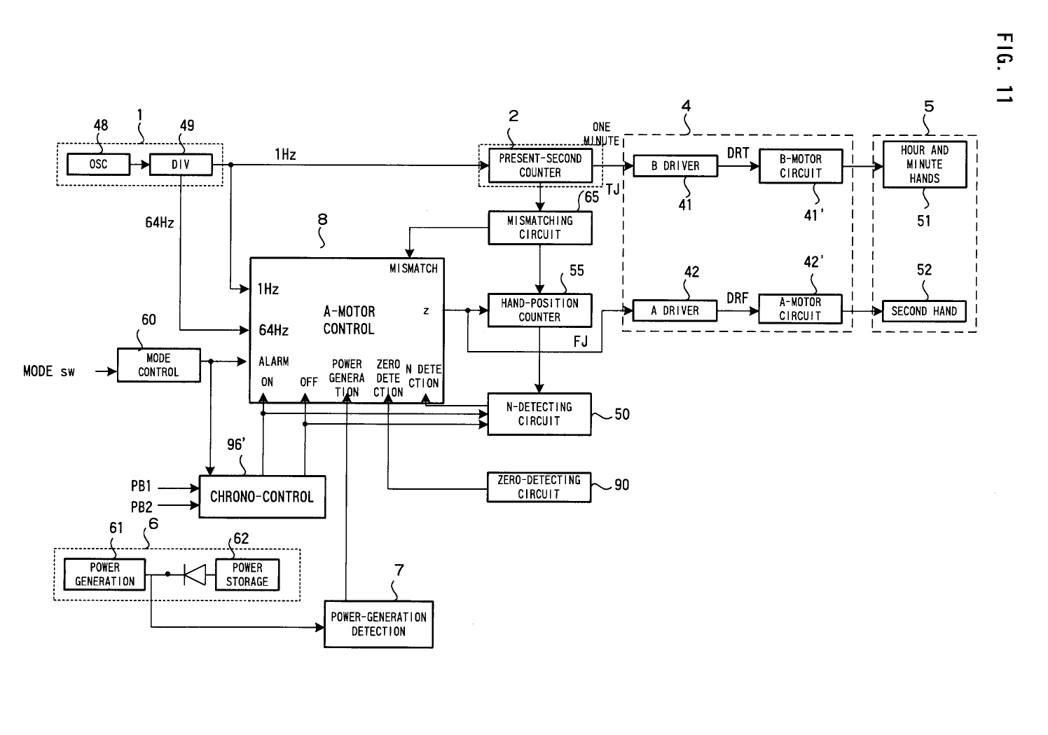

Then, cases of detecting the power-saving operation state and using the alarm display function as an example of the additional functions are described below by referring to the block diagram in FIG. 11. Therefore, the controlling means 8 in this example operates the alarm display function as one of function information. A component same as that of the block diagram shown in FIG. 7 is provided with the same number and its description is omitted.

The circuit configuration in an configuration example shown in FIG. 11 is different from the block diagram in FIG. 7 in that the chronographic display function controlling means 96 is changed to an alarm function information generating means 96′, an N-detecting circuit 50 is used which detects a value N of the hand position counter 55, a chronographic minute hand 30, and the display drive means 95 for driving the chronographic minute hand 30 are omitted. The value 42 is set to the N-detecting circuit 50 when it moves to the alarm on position 31 and the value 38 is set to the circuit 50 when it moves to the alarm off position 32.

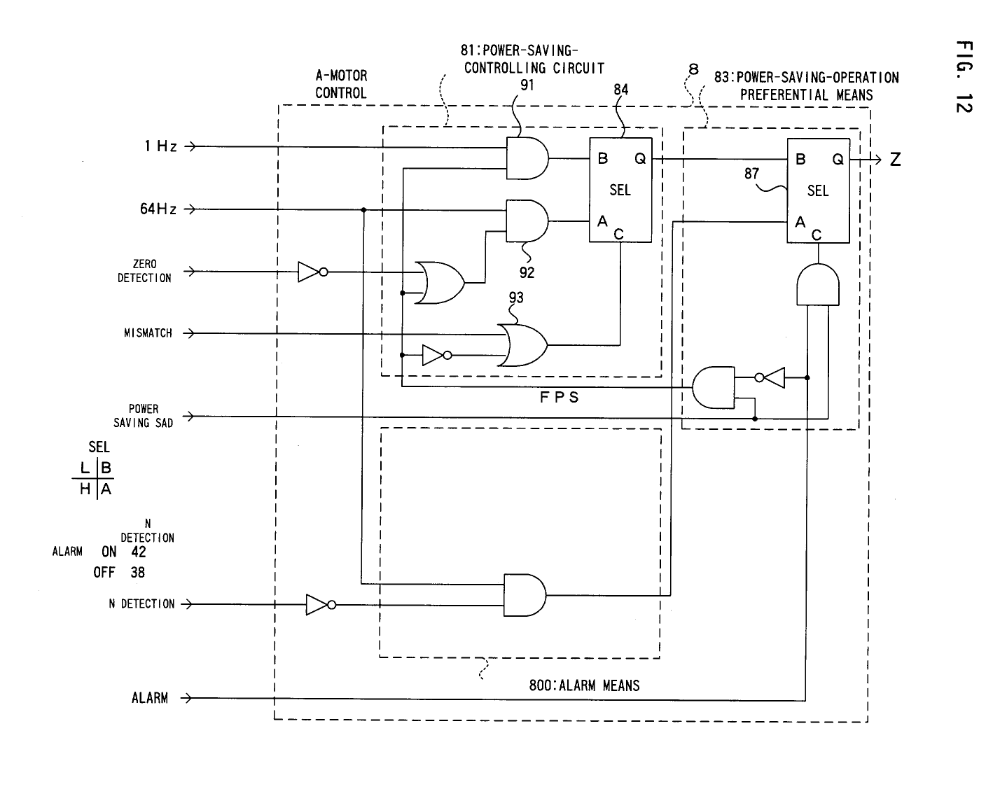

FIG. 12 shows a more specific circuit configuration of the controlling means 8 used for this configuration. In this case, a component same as that shown in FIG. 8 is provided with the same number and its description is omitted. The configuration shown in FIG. 12 is different from the configuration shown in FIG. 8 in that chronographic means 82 is changed to alarm means 800 and a signal is supplied from the N-detecting circuit 50.

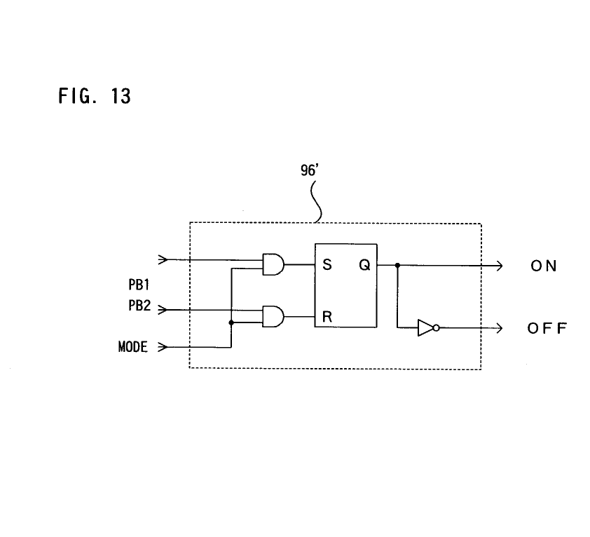

Moreover, it is possible to use the circuit configuration shown in FIG. 13 as a configuration example of the alarm function information generating means 96′. In the case of this configuration, signals output from the buttons PB1 and PB2 and a selection signal output from the mode selecting means 33 are input to the alarm function information generating means 96′ and an on-signal showing that an alarm sounding permission state is set and an off-signal showing that an alarm sounding inhibition state is set are output. The on-signal and off-signal are input to the on-terminal and off-terminal of the controlling circuit 8 and the N-detecting circuit 50.

Then, in the case of a configuration having an alarm function as the above additional function, operations of a power-saving operation state are described.

In the power-saving operation state, if a case in which a user wants to use the alarm function occurs, the user first drives the mode controlling circuit 60 by operating the crown 33 and moves the mode display hand 25 to the alarm function position ALM 28.

In the case of the above operation, when the electronic timepiece 10 is set to the alarm sounding permission, the second hand 23 moves to the alarm on position 31 and when the electronic timepiece 10 is set to the alarm sounding inhibition, the second hand 23 moves to the alarm off position 32 and stops at each position.

In the above state, when a user presses a proper operation button such as the button PB1 of the electronic timepiece 10, the second hand 23 stops at the alarm on position 31 when it is present at the position while the second hand 23 moves to the alarm on position 31 when it is present at the alarm off position 32.

Moreover, when pressing the button PB2, the second hand 23 moves to the alarm off position 32 when it is present at the alarm on position 31 while the second hand 23 stops at the alarm off position 32 when it is present at the position 32.

Therefore, the second hand 23 is set to the alarm on position 31 or alarm off position 32 in accordance with its internal set state or by operating the button PB1 or PB2. Moreover, though not illustrated, an alarm time can be adjusted by drawing the crown 33 and rotating the hour hand 21 and minute hand 22 through electromagnetic correction.

Thus, to set the alarm function to an operation state, the controlling means 8 of this configuration performs control so as to stop the alarm function or cancel the start command for starting the alarm function and make the power-saving operation state display prior to the function operation state display.

Therefore, when this configuration is kept in the power-saving operation state, even if a condition for an additional function of an alarm or the like to start a function operation state is satisfied, the function operation is canceled and the power-saving operation state is preferentially maintained. Moreover, when a condition of the power-saving operation state is satisfied in the function operation state, the function operation is stopped and the power-saving operation is started.

For this configuration, in the case of an aspect for giving priority to the power-saving operation state, it is allowed to set a state of stopping the hour hand 21 and minute hand 22 and fixing the second hand 23 to the zero-hour position as described above or set a state of continuing normal timepiece operations of the hour hand 21 and minute hand 22 and fixing only the second hand 23 to the zero-hour position.

Then, a configuration example according to digital display is described below as other configurations of the above electronic timepiece and electronic timepiece driving method of the present invention.

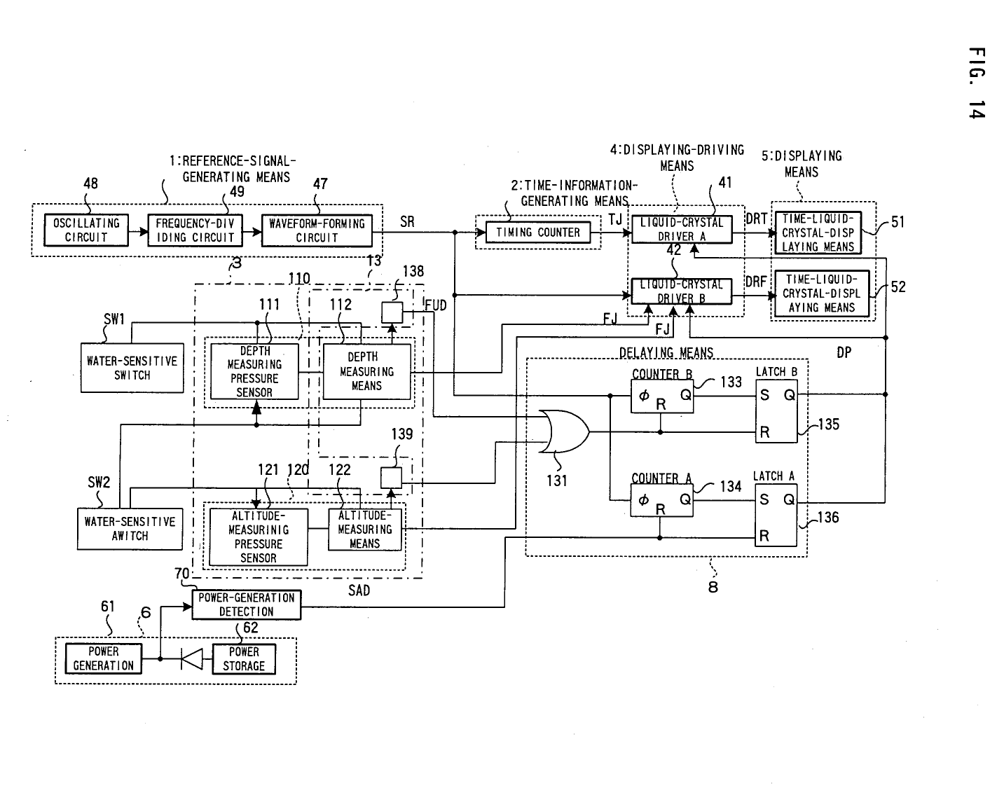

FIG. 14 shows a third configuration example of the present invention, in which a liquid crystal display unit is used as display means, a liquid crystal driver is used as display drive means, time liquid crystal display means 51 for display time information and function liquid crystal display means 52 for display function operation information on additional functions are separately provided, and depth measuring means 110 and altitude measuring means 120 are adopted as an additional function means.

The circuit configuration example shown in FIG. 14 is provided with reference signal generating means 1, time information generating means 2, function information generating means 3, liquid crystal drivers 41 and 42, time liquid crystal display means 51, function liquid crystal display means 52, and controlling means 8.

The reference signal generating means 1 is constituted by an oscillation circuit 48, frequency dividing circuit 49, and a proper waveform forming circuit 47. The time information generating means 2 generates time information TJ in accordance with a reference signal SR supplied from the reference signal generating means 1. The function information generating means 3 generates function information FJ. The liquid crystal drivers 41 and 42 output driving signals DRT and DRF to the time liquid crystal display means 51 and function liquid crystal display means 52 in order to separately display time information or function information in accordance with the function information FJ and time information TJ. The time liquid crystal display means 51 and function liquid crystal display means 52 display the function information FJ and time information TJ in accordance with the driving signals DRT and DRF supplied from the liquid crystal drivers 41 and 42.

The controlling means 8 performs control so as to make the power-saving operation state prior to the function operation state in display the display means 51 and 52 in accordance with a function operation state detecting signal FUD supplied from detecting circuits 138 and 139 serving as the function operation detecting means 13 provided for the function information generating means 3 and a power-saving state detecting signal SAD (power-saving SAD) supplied from the power generating means 70 serving as power-saving state detecting means.

Moreover, in the case of this configuration, the function information generating means 3 is provided with depth measuring function circuit means 110 including a depth measuring pressure sensor 111 and depth measuring means 112 and altitude measuring function circuit means 120 including an altitude measuring pressure sensor 121 and altitude measuring means 122.

The depth measuring function circuit means 110 is provided with a water-sensitive switch SW1 as switching means and the altitude measuring function circuit means 120 is provided with a proper switch SW2. The depth measuring function circuit means 110 is connected to the depth measuring function detecting means 138 and the altitude measuring function circuit means 120 is connected to the altitude measuring function detecting means 139. Moreover, in the case of this configuration, a bathometer can also serve as switching means.

Moreover, the above example shows depth measuring means and altitude measuring means as the function information generating means 3. However, the above example is not restricted to combination of these means but it is possible to use other measuring means, function means and optional combination.

Furthermore, the controlling means 8 of this configuration is constituted by a two-input-terminal OR circuit 131, first counter means 133, second counter means 134, first latch means 135, and second latch means 136.

The two-input-terminal OR circuit 131 receives output signals of the depth measuring function detecting means 138 and altitude measuring function detecting means 139. The reset terminal (R) of the first counter means 133 connects with an output of the two-input-terminal OR circuit 131 and has a delay function for supplying the output signal (SR) of the reference signal generating means 1 to the input terminal (φ) of the first counter means 133. The reset terminal (R) of the second counter means 134 receives the power-saving state detecting signal SAD (power-saving SAD) from the power generation detecting means 70 and has a delay function for supplying the output signal (SR) of the reference signal generating means 1 to the input terminal (φ) of the second counter means 134. The set terminal (S) of the first latch means 135 receives an output of the first counter means 133 and the reset terminal (R) of the means 135 receives an output of the two-input-terminal OR circuit 131 and the output of the means 135 is connected to the liquid crystal driver 42 for driving the function information display means 52. The set terminal (S) of the second latch means 136 receives an output of the second counter means 134 and the reset terminal (R) of the means 136 receives the power-saving state detecting signal SAD (power-saving SAD) and the output of the means 136 is connected to the liquid crystal driver 41 for driving the time information display means 51.

For the controlling means 8, a case is first described in which the electronic timepiece 10 performs the normal operation state.

In the normal operation state, an “H” level SAD signal showing a state in which power is normally generated is output from the power generation detecting means 70. However, output signals of the depth measuring function detecting means 138 and altitude measuring function detecting means 139 are both kept at “L” level. Therefore, because the SAD signal is kept at “H” level, the second counter 134 is kept in a reset state. However, the second latch means 136 is reset and an “L” level output signal is output from the output Q.

In this case, “L” level signals output from outputs Q of the latch means 135 and 136 show that they are kept in the normal operation mode and are set so as to drive the liquid crystal drivers 41 and 42 and display-drive the liquid crystal display means 51 and 52. However, it is assumed that “H” level signals output from outputs Q of the latch means 135 and 136 shows that they are kept in the power-saving mode and are set so as to stop display driving of the liquid crystal display means 51 and 52.

Therefore, in the above normal operation state, the time liquid crystal display means 51 is display-driven in accordance with the “L” level signal of the second latch means 136.

However, the first counter 133 is constituted so that the reset state of the counter 133 is canceled in accordance with an “L” level signal serving as an output of the two-input-terminal OR circuit 131 and the counter 133 starts counting and when a predetermined count is counted up, a set signal is supplied to the set terminal S of the first latch means 135 from the output Q of the first counter 133, and an “H” level signal is output from the output Q of the first latch means 135.

Therefore, the driving operation of the liquid crystal driver 42 of the function information display means 52 is stopped and resultantly, the time information display means 51 is driven, and the function information display means 52 stops display. That is, in the normal power-generating state, only the time information display means 51 is kept in a display state.

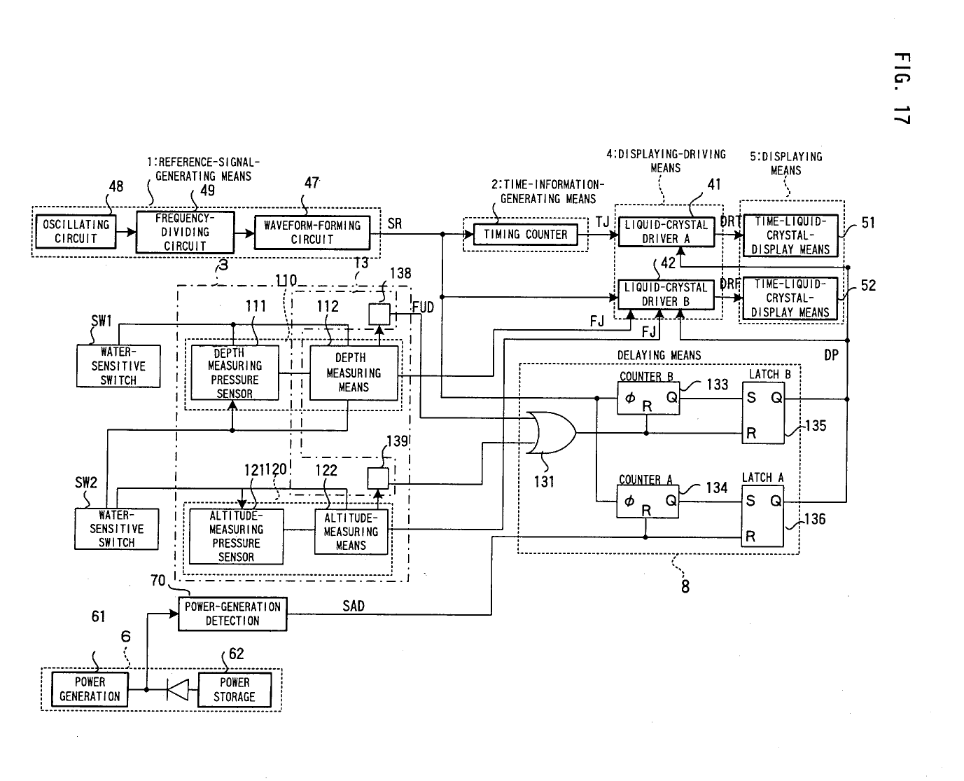

However, either or both of the function information generating means is or are operated through switching means. Particularly, in the case of the depth measurement and water-temperature measurement in FIG. 17 to be described later, either or both of output signals of the depth measuring function detecting means 138 and water-temperature measuring function detecting means 139 may be an “H” level signal or “H” level signals.

When at least one of the output signals FUD of the function detecting means 138 and 139 becomes “H” level, an output of the two-input-terminal OR circuit 131 becomes an “H” level signal. Therefore, an output of the first latch means 135 becomes “L” level because of the above reason and the function information display means 52 is display-driven. Moreover, in the normal power-generating state, because the SAD signal is kept at “H” level, an output of the second latch means 136 becomes “L” level and the time information display means 51 is display-driven.

Therefore, both the time information display means 51 and function information display means 52 are display-driven.

Then, the normal operation state and power-saving operation state are described below. In FIG. 14, when neither function information generating means 110 nor function information generating means 120 is operated or generates power, the SAD signal output-from the power generation detecting means 70 becomes “L” level. The reset state of the second counter 134 is canceled in accordance with an “L” level signal serving as the SAD signal output and the counter 134 starts counting and when a predetermined count is counted up, a set signal is supplied to the set terminal of the second latch means 136 from the output Q. Because an “H” level signal is constituted so as to be output from the output Q of the second latch means 136, the time liquid crystal display means 51 is brought into the power-saving operation state and the display operation is stopped. During the above period, the display operation of the function information display means 52 is also stopped.

Then, a case is described in which a function operation occurs under the power-saving operation state. Even while the display operation of the time liquid crystal display means 51 is stopped under the power-saving operation state and any of the function information generating means is operated, a signal input to the reset terminal (R) of the second counter 134 is still kept as an “L” level signal serving as the SAD signal output. Therefore, a signal output from the second latch means 136 is still kept at “H” level, the power-saving operation state of the time information display means 51 is maintained, and time display is still stopped.

Moreover, even if it is necessary to drive the power-saving operation state while the function operation state is executed, a signal to be input to the reset terminal (R) of the second counter 134 is always the L level SAD signal. Therefore, the power-saving operation state of the time information display means 51 is kept and time display is kept stopped. Therefore, the power-saving operation is performed preferentially to the function operation.

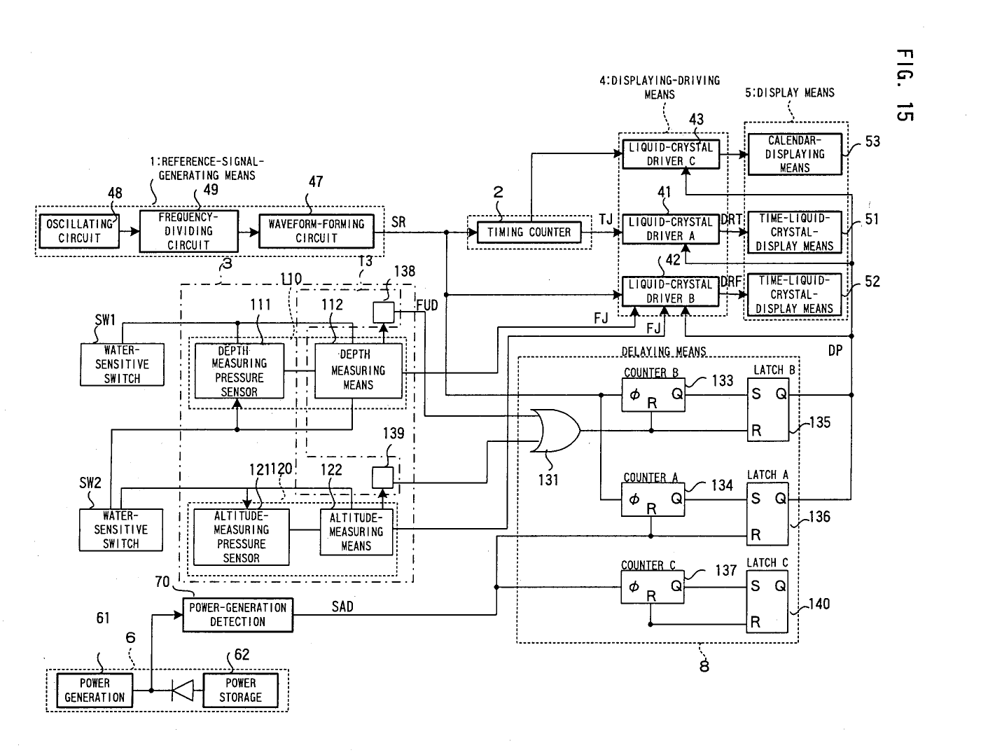

Then, a fourth configuration of the present invention is described below by referring to FIG. 15.

The configuration example shown in FIG. 11 is basically the same as the configuration example shown in FIG. 14 but the former is different from the latter in that three types of display means are used and one of them is constituted so that it is directly controlled in accordance with the power-saving operation state detecting signal SAD (power-saving SAD) supplied from the power generation detecting means 70 independently to presence or absence of a function-display operation state.

That is, the configuration example shown in FIG. 15 uses the configuration in FIG. 14 in which liquid crystal display means 53 for display a calendar, a liquid crystal driver 43 for driving the means 53, a third counter 137, and third latch means 140 connected thereto are further included.

In the case of the third counter 137, the reset terminal (R) of the counter 137 is connected to the power generation detecting means 70, an output signal of the reference signal generating means 1 is input to an input terminal (φ), and the output (Q) of the means 1 is input to the set terminal (S) of the third latch means 140. Moreover, the reset terminal (R) of the third latch means 140 is connected to the power generation detecting means 70, and the output (Q) of the means 140 is connected to the liquid crystal driver 43.

Therefore, because basic operations of this configuration are the same as those of the configuration example in FIG. 14, detailed description of the operations is omitted. However, also in the case of the newly-provided calendar display means 53, the latch means 140 is not related to an output signal of the function operation state detecting means 13 but the latch means is constituted so that it is driven in accordance with an output signal of the power generation detecting means 70. Therefore, the means 53 starts a power-saving operation mode or performs a display operation in the normal display mode independently of the presence or absence of a function operation state according to the state of power state. Therefore, the power-saving operation state is operated preferentially to the function operation state.

As described about the above configuration, in the case of the present invention, it is more preferable that delaying mans is further used which shifts the normal operation state to the power-saving operation state after a condition for starting the power-saving operation state is satisfied and then a predetermined delay time is counted. Thus, it is possible to shift the display means to the display state showing the power-saving operation state. Moreover, it is preferable to use a configuration of resetting delaying means when the function information generating means is brought into an operation state.

Another configuration of the present invention is an electronic timepiece driving method using an electronic timepiece having a power-saving operation state consuming a power less than the normal operation state and making it possible to selectively display time information or function information, in which the power-saving operation is made prior to the function-information display operation.

More minutely, the method uses an electronic timepiece comprising reference signal generating means, time information generating means for generating time information in accordance with a reference signal supplied from the reference signal generating means, function information generating means for generating function information, display drive means for outputting a driving signal for display function information and time information, and display means for display function information and time information in accordance with a driving signal supplied from the display drive means and having a power-saving operation state consuming a power less than the normal operation state, in which control is performed so as to make the power-saving operation state prior to the function operation state of the function information generating means.

As a more specific configuration of an electronic timepiece driving method of the present invention, it is allowed to realize a method using an electronic timepiece comprising reference signal generating means, time information generating means for generating time information in accordance with a reference signal supplied from the reference signal generating means, function information generating means for generating function information, display drive means for outputting a driving signal for display function information and time information, and display means for display function information and time information in accordance with a driving signal supplied from the display drive means and having a power-saving operation state consuming a power less than the normal operation state, in which control is performed so as to cancel generation of function information and maintain the power-saving operation state when the function information generating means is brought into an operation state during the power-saving operation state.

Moreover, it is allowed to realize a method using an electronic timepiece comprising reference signal generating means, time information generating means for generating time information in accordance with a reference signal supplied from the reference signal generating means, function information generating means for generating function information, display drive means for outputting a driving signal for display function information and time information, and display means for display function information and time information in accordance with a driving signal supplied from the display drive means and having a power-saving operation state consuming a power less than the normal operation state, in which when a condition for the function information generating means to start the power-saving operation state during an operation state is satisfied, it is allowed to stop the operation state of the function information and perform control so that the power-saving operation state is set.

Furthermore, in the case of an electronic timepiece driving method of the present invention, it is allowed that display drive means is-constituted so as to drive time information display means and/or function information display means when a power-saving operation state is canceled. Furthermore, it is allowed to use display drive means constituted so as to determine whether an output voltage or output current of power generating means is sufficient for an operation state of time information display means and/or function information display means and stop display the time information display means and/or function information display means.

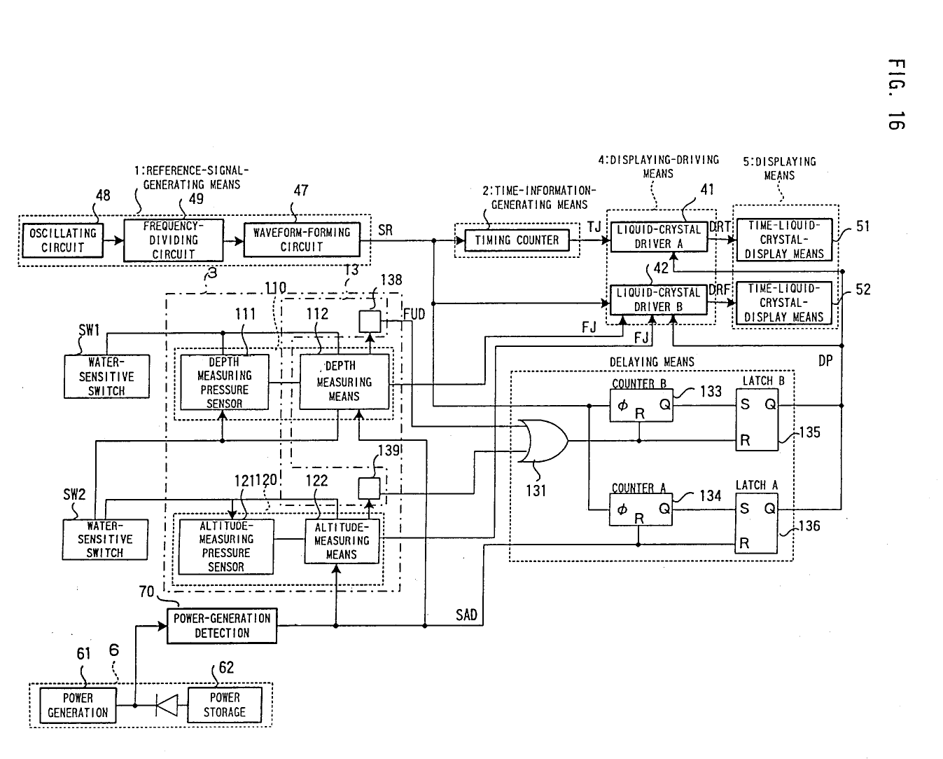

FIG. 16 shows a fifth configuration example of the present invention in which display means is replaced with a liquid crystal display and display drive means is changed to liquid crystal driver, liquid crystal display means for display time information and function operation state display means for display function operation information are separately provided, and depth measuring means and altitude measuring means are adopted as additional-function means the same as the case of the third configuration in FIG. 14. In FIG. 16, an element same as that of the third configuration example in FIG. 14 is provided with the same symbol and its description is omitted.

The fifth configuration is different from the third configuration in FIG. 14 in that the SAD signal of the power generation detecting means 70 is connected to control terminals of the depth measuring means 110 and altitude measuring means 120 to stop functions of the depth measuring means 110 and altitude measuring means 120 under the power-saving operation state.

Also in the case of the first configuration example in FIG. 3, when an instruction which is not a chronographic mode at present is output from the mode controlling circuit 60, control for stopping a not-chronographic mode circuit among circuits in the controlling means 8 is performed. It is an effective power-saving method to stop, as a power-saving operation state, not only a part or the whole of the display means 5 but also circuits which do not have to be operated in each mode among IC circuits for driving an electronic timepiece.

FIG. 17 shows a sixth configuration example of the present invention in which display means is replaced with a liquid crystal display, display drive means is changed to a liquid crystal driver, time liquid crystal display means for display time information and function operation state display means for display function operation information are separately provided, and depth measuring means 110 and temperature measuring means are adopted.

In the case of the third configuration example shown in FIG. 14, the function liquid crystal display means 52 is not displayed independently of the fact whether the power generating means 61 generates power or not when no additional function is used. However, in the case of the sixth configuration in FIG. 17, a specification is used in which the liquid crystal display of the function liquid crystal display means 52 is not turned off when power is generated the same as the case of the time liquid crystal display means 51.

To change the above specification, an OR circuit 888 is used instead of the OR circuit 131 in FIG. 11 and the signal SAD output from the power generation detecting means 70 is used as an additional input. In FIG. 17, an element same as that of the third configuration example in FIG. 14 is provided with the same symbol and its description is omitted.

Moreover, the sixth configuration example is different from the third configuration example in FIG. 14 in that a temperature measuring function including water-temperature measurement is used instead of an altitude measuring function and it is possible to measure temperatures by using a temperature sensor 921 for a thermometer and temperature measuring means 922.

In FIG. 17, though depth measurement and water-temperature measurement (temperature measurement) are independently operated, it is also possible to execute depth measurement and water-temperature measurement at the same time in accordance with a water-sensitive switch SW1.

Moreover, when an electronic timepiece is rechargeable and a power generating electronic timepiece having power generating means such as a solar battery, time adjustment warning function information for warning a time error when the timepiece is temporarily stopped due to insufficient charge and then restarted by being recharged, a charge warning function information for prompting charging, or residual capacity warning function information for display the residual capacity of a secondary battery or a capacitor serving as electricity storing means is one of function information of the present invention.

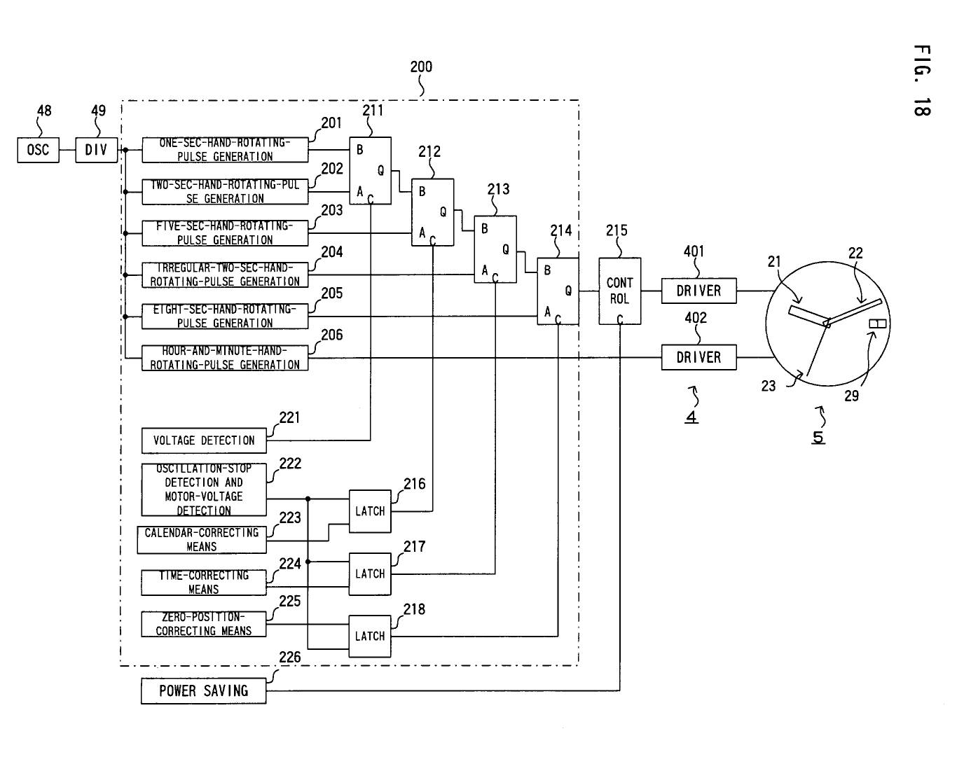

Then, a configuration and operations for making a power-saving function prior to such function information as the time adjustment warning function information, charge warning function information, and residual capacity warning function information are described below by referring to FIGS. 18 to 29.

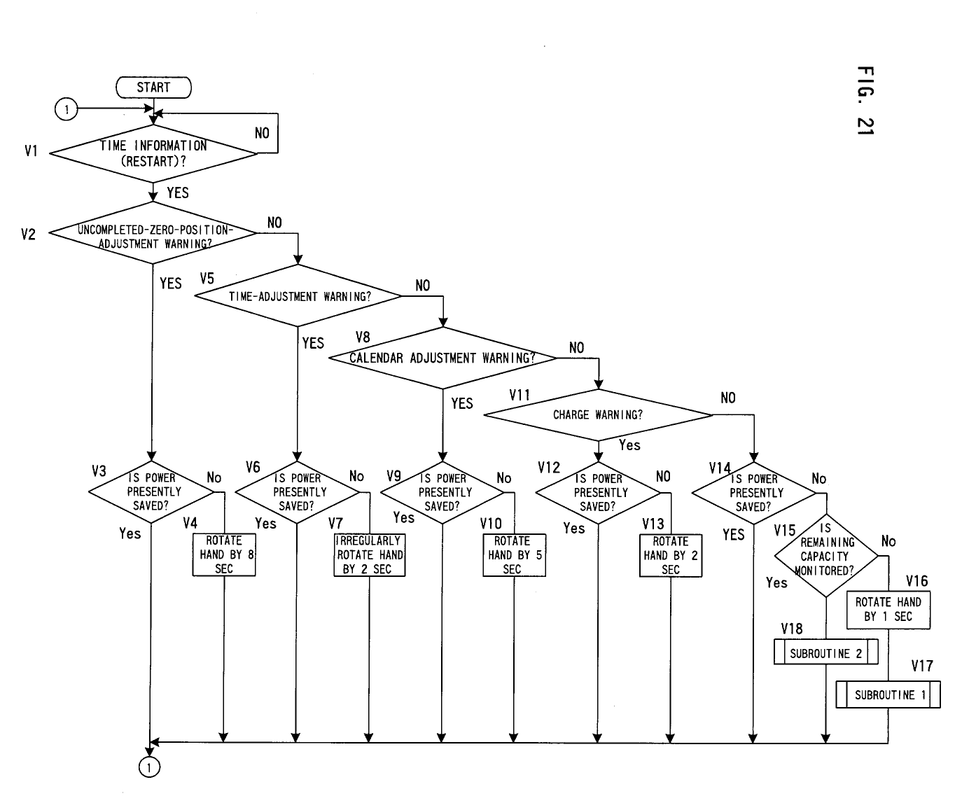

FIGS. 18 to 20 are a block diagram, a flowchart, and timing charts for explaining analog configurations and operations for making a power-saving function prior to function states such as a time adjustment warning function information, and charge warning function information and FIGS. 21 to 24 are flowcharts and timing charts for explaining operations of an analog configuration for making a power-saving operation state prior to function states of residual capacity warning function information in addition to function states of warning function information and charge warning function information.

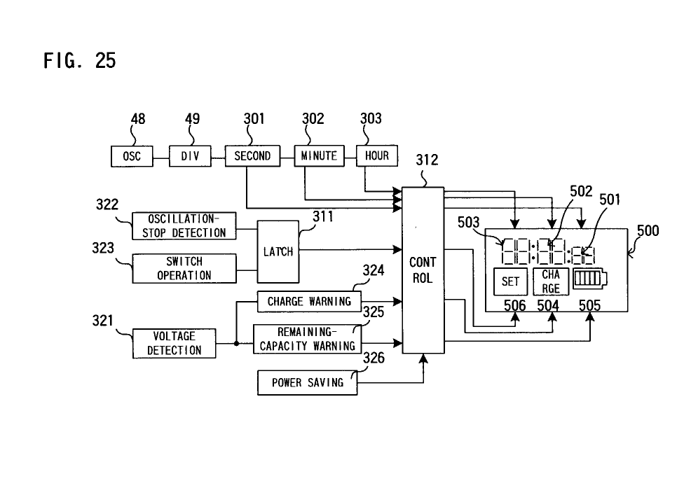

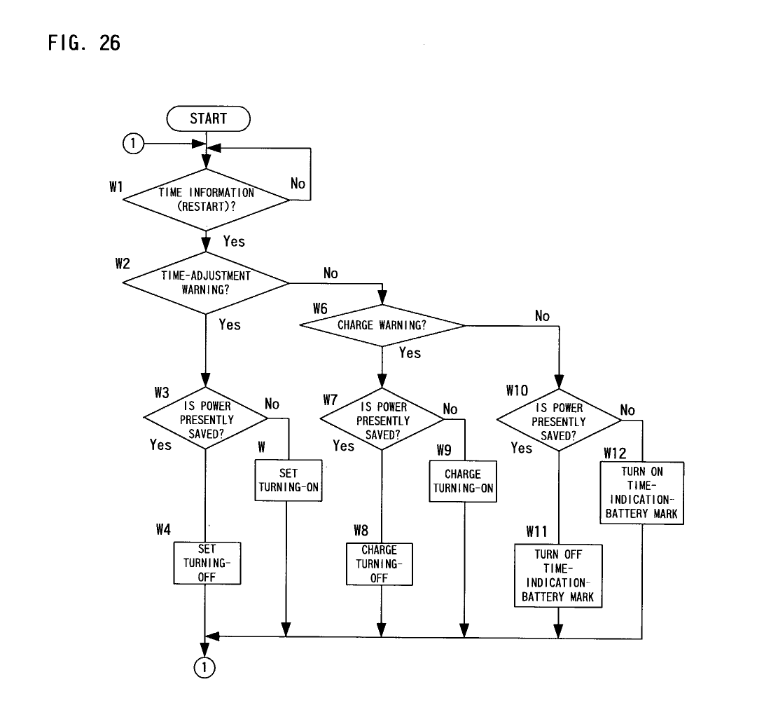

FIGS. 25 and 26 are a block diagram and a flowchart for explaining digital configuration and operations for making a power-saving function prior to function information such as time adjustment warning function information, charge warning function information, and residual capacity warning function information.

The configuration shown in FIG. 18 shows a timepiece having a configuration for performing analog display, which comprises a display means 5 having an hour hand 21, a minute hand 22, a second hand 23, and a day plate and display drive means 4 for driving the display means 5. In this case, a configuration is shown in which the display drive means 4 is provided with driver circuits 401 and 402 and the driver circuit 401 drives the second hand 23 and the driver circuit 402 drives the hour hand 21 and minute hand 22.

The oscillation circuit 48 and frequency dividing circuit 49 for constituting reference signal generating means respectively output a reference signal (SR) The reference signal drives the second hand 23, hour hand 21, and minute hand 22 by the driver circuits 401 and 402 to display time information and moreover, it is formed into a pulse signal corresponding to each state in a timepiece circuit portion 200 including warning controls such as time adjustment and charge warning to drive the second hand 23 by the driver circuit 401 and display a time adjustment warning for warning a time error at the time of restart and a charge warning for prompting charge. The second hand 23 is driven in accordance with a 1 sec-hand rotating pulse signal formed by 1-sec rotating-pulse forming means 201 and the hour hand 21 and minute hand 22 are driven in accordance with an hour and minute hand rotating pulse signal formed by hour-and-minute-hand rotating-pulse-forming means 206.

The timepiece circuit portion 200 is provided with 1-sec rotating-pulse forming means 201 for forming a pulse signal for rotating the second hand 23 every second, 2-sec rotating-pulse forming means 202 for forming a pulse signal for rotating the second hand 23 every two seconds in order to warn that a power source voltage is lowered and thereby charging is necessary, 5-sec rotating-pulse forming means 203 for forming a pulse signal for rotating the second hand 23 every five seconds in order to wan that driving of a day plate is stopped and calendar adjustment is necessary, irregular 2-sec rotating-pulse forming means 204 for forming a pulse signal for irregularly rotating the second hand 23 every two seconds in order to warn that time adjustment is necessary because displayed information is stopped, and 8-sec rotating-pulse-forming means 205 for forming a pulse signal for rotating the second hand 23 every eight seconds in order to warn that the second hand 23 is not set to the position of 0 sec. Warnings of time adjustment, charging, calendar adjustment, 0-position alignment unfinished are displayed by the pulse signals formed by the above pulse-forming means.

Warnings to be displayed among the above warnings are selected by selectors 211 to 214. The selector 211 selects either of signals input to input terminals A and B in accordance with a selection signal input to the selection terminal C from voltage detecting means 221 and outputs a 1 sec-hand rotating pulse signal or 2 sec-hand rotating pulse signal from the output terminal Q in accordance with a power source voltage. For example, when the power source voltage is lowered to a predetermined voltage or lower, the selector 211 outputs a 2 sec-hand rotating pulse signal and warns charging.

Moreover, the selector 212 selects either of signals input to input terminals B and A in accordance with a selection signal input to the selection terminal C from a latched circuit 216 latched in accordance with a detection signal of oscillation stop detecting means (or detecting means for detecting that a power source voltage is lowered to a voltage required to drive a motor or lower) 222 and outputs an output signal of the selector 211 or a 5 sec-hand rotating pulse signal from the output terminal Q in accordance with oscillation stop (or drop of a power source voltage). For example, when oscillation stops, the selector 212 outputs a 5 sec-hand rotating pulse signal to warn calendar adjustment. When a day plate is corrected by calendar correcting means 223 in accordance with the calendar adjustment warning, an output signal of the selector 211 is output by resetting the latched circuit 216 and thereby changing selection of the selector 212.

Furthermore, the selector 213 selects either of signals input to input terminals B and A in accordance with a selection signal input to the selection terminal C from a latched circuit 217 latched in accordance with a detection signal of oscillation stop detecting means (or detecting means for detecting that a power source voltage is lowered to a voltage required to drive a motor or lower) 222 and outputs an output signal of the selector 212 or an irregular 2 sec-hand rotating pulse signal from the output terminal Q in accordance with oscillation stop (or drop of a power source voltage). For example, when oscillation stops, the selector 213 outputs an irregular 2 sec-hand rotating pulse signal to warn time adjustment. When time is corrected time by time correcting means 224 in accordance with the above time adjustment warning, an output signal of the selector 212 is output by resetting the latched circuit 217 and thereby changing selection of the selector 213.

Furthermore, the selector 214 selects either of signals input to input terminals B and A in accordance with a selection signal input to the selection terminal C from a latched circuit 218 latched in accordance with a detection signal of the oscillation stop detecting means (or detecting means for detecting that a power source voltage is lowered to a voltage required to drive a motor or lower) 222 the same as the selectors 212 and 213 do and outputs an output signal of the selector 213 or an 8 sec-hand rotating pulse signal from the output terminal Q in accordance with oscillation stop (or drop of a power source voltage). For example, when oscillation stops, the selector 214 outputs an 8 sec-hand rotating pulse signal to warn that 0-position alignment is not completed. When the second hand 23 is adjusted to zero position by the 0-position correcting means 225 in accordance with the above 0-position alignment unfinished warning, an output signal of the selector 213 is output by resetting the latched circuit 218 and thereby changing selection of the selector 214.

To make power saving prior to the above function information, the configuration shown in FIG. 18 is provided with power-saving state detecting means 226 and controlling means 215. The controlling means 215 inputs a detection signal supplied from the power-saving state detecting means 226 to the selection terminal C, controls whether to transmit a signal for display the function information supplied from the selector 214 to the driver circuit 401, stops transmission of the function information from the selector 214 to the driver circuit 401 when power is saved, and stops display by the display means 5.

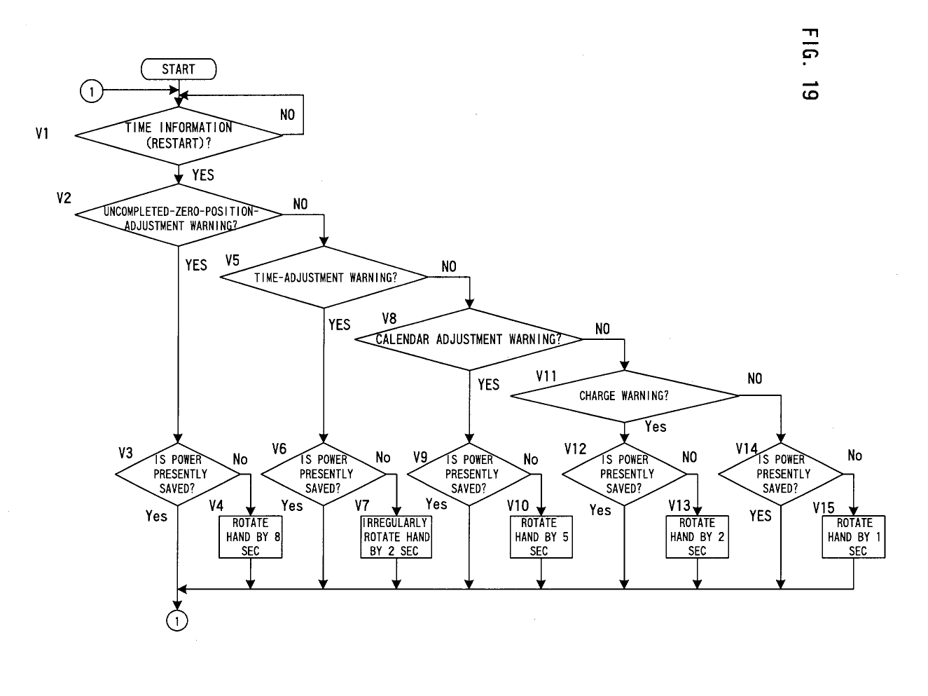

A power-saving preferential operation by the above configuration is described below in accordance with the flowchart shown in FIG. 19.

When an power generating electronic timepiece having power generating means such as a solar battery is provided with the above configuration, if charge deficiency occurs, the electronic timepiece selects the A terminal of the selector 211 in accordance with a detection signal of the voltage detecting means 221, sets the latched circuits 216 to 218 in accordance with a detection signal of the oscillation stop detecting means 222, selects A terminals of the selectors 212 to 214, and thereby various warnings including temporary stop of a timepiece are output.

When the electronic timepiece is restarted from each of the warning states by being recharged, and time information is input, for example, a reference signal is input to the timepiece circuit portion 200 from the oscillation circuit 48 and frequency dividing circuit 49 (step V1), the timepiece circuit portion 200 first determines whether a warning that 0-position alignment is not completed is output. This determination can be performed in accordance with the fact that the latched circuit 218 is set or reset (step V2).

When the 0-position alignment is not completed (while the latched circuit 218 is set), it is determined whether power is presently saved (step V3) and when a power-saving signal is output from the power-saving state detecting means 226, it is determined that power is presently saved and the controlling means 215 returns to step V1 while keeping stopping outputting a signal from the timepiece circuit portion 200. However, unless power is presently saved, the controlling means 215 selects an 8 sec-hand rotating pulse signal from the selector 214 and intermittently drives the second hand 23 every 8 sec to display that 0-position alignment is uncompleted (step V4).

When 0-position alignment is completed (while the latched circuit 218 is reset), it is determined whether a time adjustment warning is output. This determination can be performed in accordance with the fact that the latched circuit 217 is set or reset (step V5). When the time adjustment warning is output (while the latched circuit 217 is set), it is determined whether power is presently saved (step V6) and when a power-saving signal is output from the power-saving state detecting means 226, it is determined that power is presently saved, and the controlling means 215 returns to step V1 while stopping outputting a signal from the timepiece circuit portion 200. However, unless power is presently saved, the controlling means 215 selects an irregular 2 sec-hand rotating pulse signal through the selectors 213 and 214 and drives the second hand 23 every 2 sec at irregular intermittent intervals to display that time adjustment is uncompleted (step V7).

When time adjustment is completed (while the latched circuit 217 is reset), it is determined whether a calendar adjustment warning is output. This determination can be performed in accordance with the fact that the latched circuit 216 is set or reset (step V8). When the calendar adjustment warning is output (while the latched circuit 216 is set), it is determined whether power is presently saved (step V9), when a power-saving signal is output from the power-saving state detecting means 226, it is determined that power is presently saved, and the controlling means 215 returns to step V1 while stopping outputting a signal from the timepiece circuit portion 200. Unless power is presently saved, the controlling means 215 selects a 5 sec-hand rotating pulse signal through the selectors 212, 213, and 214, drives the second hand 23 every 5 sec at intermittent intervals, and displays that calendar adjustment is uncompleted (step V10).

When calendar adjustment is completed (while the latched circuit 216 is reset), it is determined whether a charge warning is output. This determination can be performed in accordance with an output of the voltage detecting means 221 (step V11). When a charge warning is output (while a signal showing a voltage drop is output from the voltage detecting means 221), it is determined whether power is presently saved (step V12) and when a power-saving signal is output from the power-saving state detecting means 226, it is determined that power is presently saved, and the controlling means 215 returns to step V1 while stopping outputting a signal from the timepiece circuit portion 200. Unless power is presently saved, the controlling means 215 selects a 2 sec-hand rotating pulse signal through the selectors 211, 212, 213, and 214, drives the second hand 23 every 2 sec at intermittent intervals, and displays that charging is insufficient (step V13).

When charging is sufficient (while a signal showing a voltage drop is not output from the voltage detecting means 221), it is determined whether power is presently saved (step V14) and when a power-saving signal is output from the power-saving state detecting means 226, it is determined that power is presently saved, and the controlling means 215 returns to step V1 while stopping outputting a signal from the timepiece circuit portion 200. Unless power is presently saved, the controlling means 215 selects a 1 sec-hand rotating pulse signal through the selectors 211, 212, 213, and 214, normally drives the second hand 23, and displays time information (step V15).

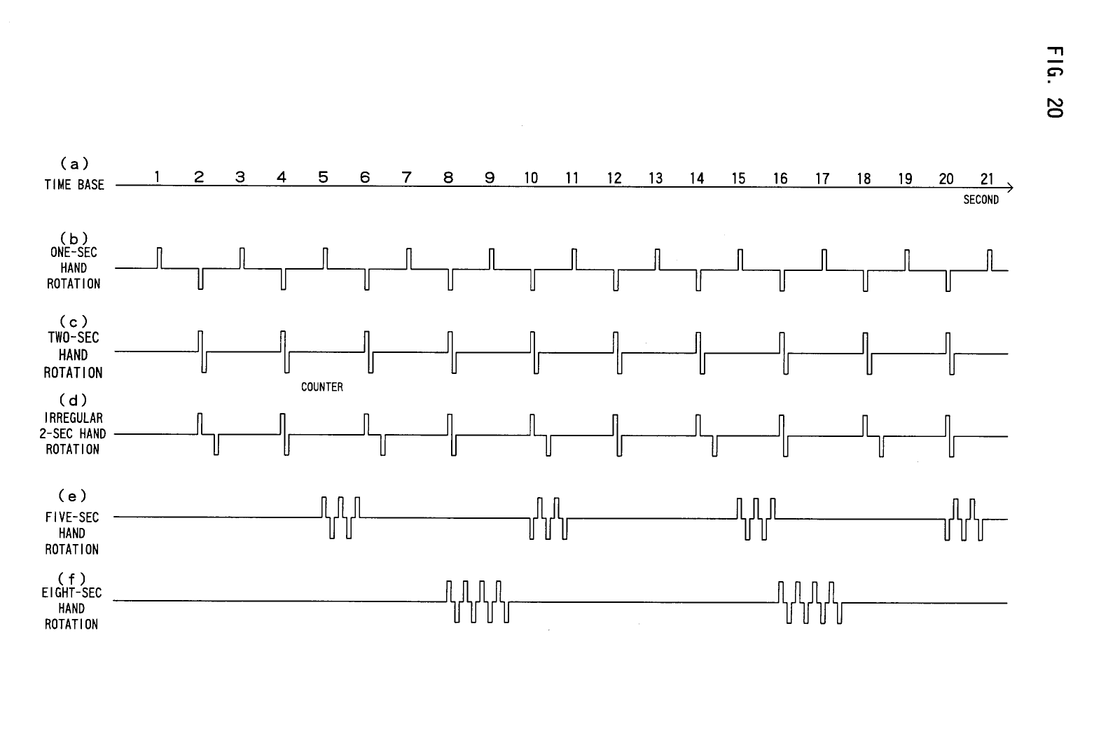

FIG. 20 shows states of a 1 sec-hand rotating pulse signal, 2 sec-hand rotating pulse signal, irregular 2 sec-hand rotating pulse signal, 5 sec-hand rotating pulse signal, and 8 sec-hand rotating pulse signal. The 1 sec-hand rotating pulse signal shown in FIG. 20(b) becomes a positive second signal for outputting a pulse signal to the time base shown in FIG. 20(a) every sec and showing time information. The 2 sec-hand rotating pulse signal shown in FIG. 20(c) outputs two pulse signals to the time base shown in FIG. 20(b) every 2 sec and displays a charge warning. The irregular 2 sec-hand rotating pulse signal shown in FIG. 20(d) outputs two pulse signals to the time base shown in FIG. 20(b) every 2 sec at signal intervals different from the case of a 2 sec-hand rotating pulse signal and displays a time adjustment warning. The 5 sec-hand rotating pulse signal shown in FIG. 20(e) outputs five pulse signals to the time base shown in FIG. 20(b) every 5 sec and displays a calendar adjustment warning. The 8 sec-hand rotating pulse signal shown in FIG. 20(f) outputs five pulse signals to the time base shown in FIG. 20(b) every 8 sec and displays a 0-position alignment unfinished warning.

The 2 sec-hand rotating pulse signal, irregular-2 sec-hand rotating pulse signal, 5 sec-hand rotating pulse signal, and 8 sect-hand rotating pulse signal are hand rotating aspects for display warnings on a second hand. However, it is also possible to display warnings in accordance with other hand rotating aspect. In this case, each hand rotating pulse signal shows a case of alternately outputting a positive signal and a negative signal.

The flowchart in FIG. 19 shows operations for making a power-saving state prior to function information for display an 0-position alignment unfinished warning, time adjustment warning, calendar adjustment warning, charge warning. Moreover, power-saving preferential operations for making a power-saving operation prior to the function information for display a residual capacity for display a charge state of power generating means are described below by referring to the flowchart in FIG. 21.

In the flowchart in FIG. 21, it is possible to make steps V1 to V14 common to each other. Therefore, steps on and after step V14 are described below.

The controlling means 215 determines in step V14 whether power is saved. When a power-saving signal is output from the power-saving state detecting means 226, the means 215 determines that power is presently saved and returns to step V1 while stopping outputting a signal from the timepiece circuit portion 200. However, unless power is presently saved, the means 215 determines whether a residual capacity monitor is operating (step V15).

When the residual capacity monitor is not operating (step V15), the second hand 23 is normally driven by a 1 sec-hand rotating pulse signal to display time information (step V16). Thereafter, when the residual capacity monitor is selected in a subroutine 1, a residual capacity is displayed (step V17). However, when the residual capacity monitor is operating (step V15), the residual capacity monitor is terminated in a subroutine 2 (step V18).

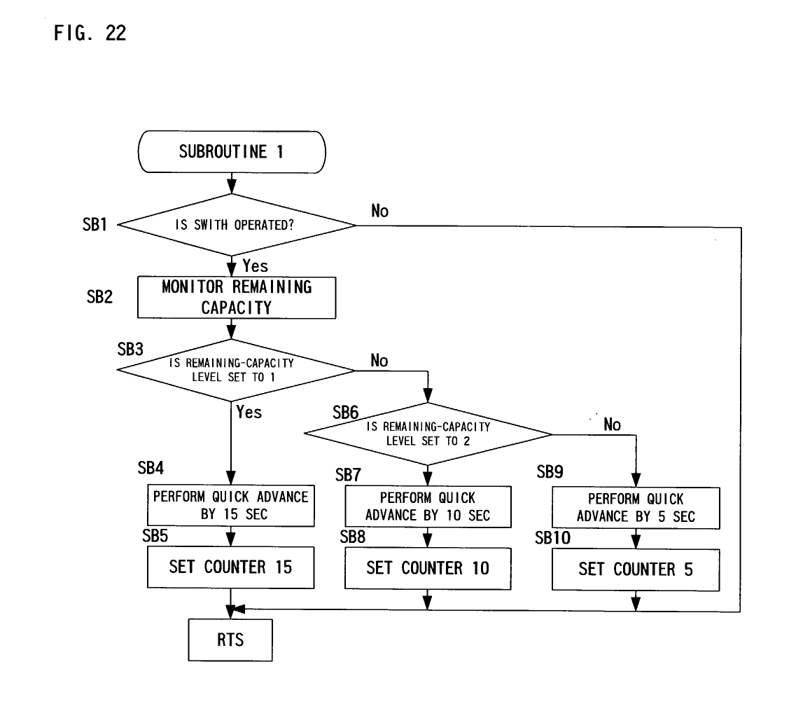

The flowchart in FIG. 22 shows operations of the subroutine 1. Whether to operate a residual capacity monitor is selected by operating a switch (step SB1). When selecting the residual capacity monitor, operations of the residual capacity monitor are started (step SB2). Then, levels 1 and 2 are set to the residual capacity monitor as threshold values to compare a voltage of power source means with the levels 1 and 2 and display a residual capacity level in accordance with the comparison result. When the voltage of the power source means is equal to or higher than the level 1 (step SB3), it is displayed that the voltage is equal to the level 1 by quickly advancing a second hand by 15 sec (step SB4) and a counter is set to 14 (step SB5). When the voltage of the power source means is kept between the level 1 and the level 2 (both included) (step SB6), it is displayed that the voltage is equal to the residual capacity level 2 by quickly advancing the second hand by 10 sec (step SB7) and the counter is set to 9 (step SB8). Moreover, when the voltage of the power source means is equal to or lower than the level 2 (step SB6), it is displayed that the voltage is equal to the residual capacity level 3 by quickly advancing the second hand by 5 sec (step SB9) and the counter is set to 4 (step SB10).

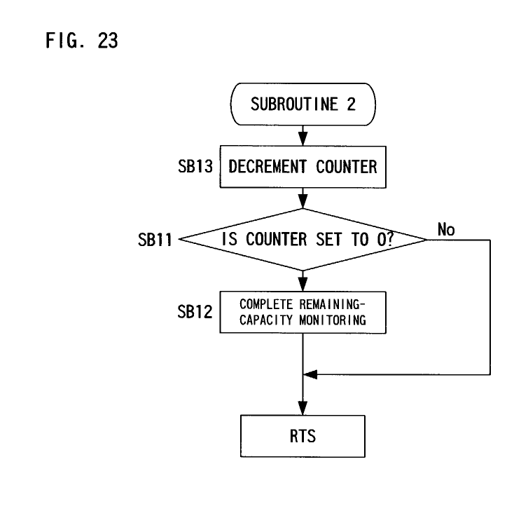

While the residual capacity monitor is displayed in accordance with the subroutine 1, processing is performed by the subroutine 2 in accordance with the determination in step V15. The flowchart in FIG. 23 shows operations of the subroutine 2. In the subroutine 2, the counter value set in the subroutine 1 is monitored to determine whether the counter value is equal to 0 (step SB11). When the counter value is not equal to 0, the processing for decreasing the set counter at value by 1 is performed (step SB13) and the determination in step SB11 is performed again after 1 sec. In this case, because the counter value to be determined is decreased, the counter value becomes 0 after a time corresponding to the set counter at value elapses and the residual capacity monitor is terminated at this point of time (step SB12). When using the voltage detecting means 221 or power generating means such as a solar cell or self-winding power generating mechanism, it is possible to constitute the residual capacity monitor by hardware or software for determining a voltage signal supplied from power generation detecting means for detecting deterioration of the power generating capacity of the power generating means by using a residual capacity level set to a predetermined value as a threshold value.

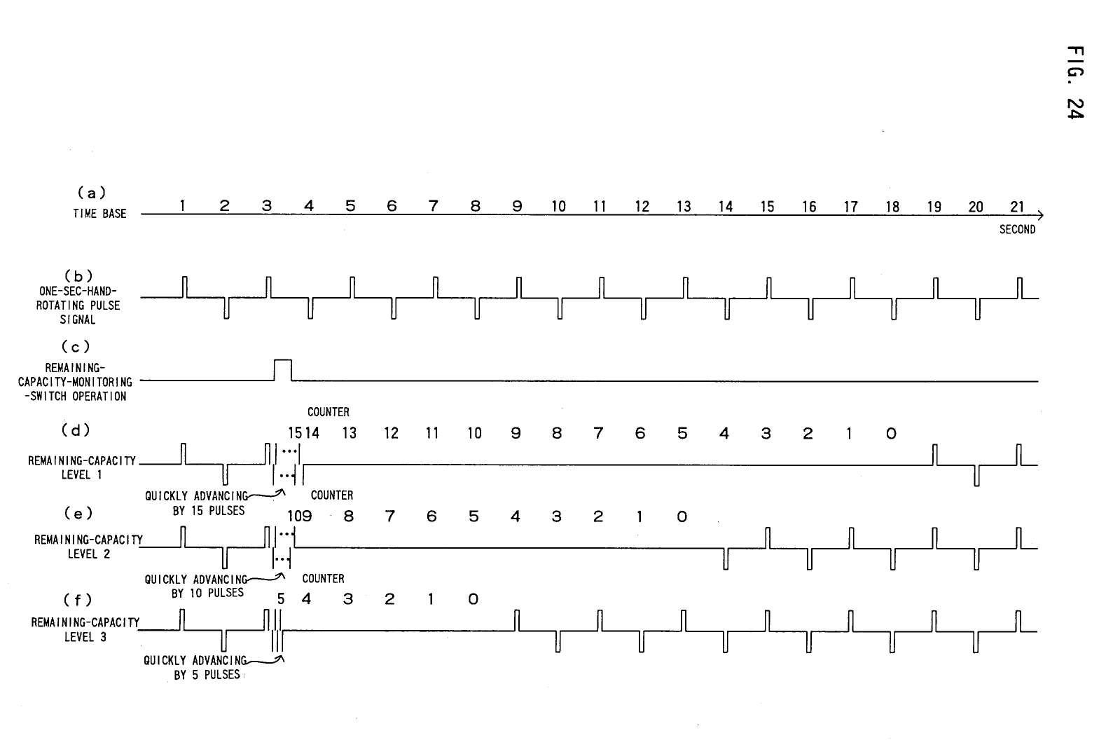

FIG. 24 is timing chart for explaining operations of a residual capacity monitor. The 1 sec-hand rotating pulse signal shown in FIG. 4(b) outputs one pulse signal to the time base shown in FIG. 24(a) every sec and displays a second operation. Under the above state, when an operation switch for operating the residual capacity monitor is set at the point of time shown in FIG. 24(c), the pulse signal in FIG. 24(d), 24(e), or 24(f) is output in accordance with the voltage state of a power source portion instead of the 1 sec-hand rotating pulse signal shown in FIG. 4(b) and a residual capacity level is displayed in accordance with the rotation of a second hand.

For example, when a voltage of a power source portion is equal to or higher than a level 1, it is displayed that a residual capacity level is equal to 1 by outputting 15 pulse signals at a short cycle and thereby quickly advancing the second hand by 15 sec as shown in FIG. 24(d). Then, a counter subtracts the counter value 15 every second to stop movement for 15 sec and restarts the normal operation after the counter indicates 0. Moreover, when the voltage of the power source portion is kept less than the level 1 and over the level 2, it is displayed that the residual capacity level is equal to 2 by outputting ten pulse signals at a short cycle and thereby quickly advancing the second-hand by 10 sec as shown in FIG. 24(e). Then, the counter subtracts the counter value 10 every second to stop movement for 10 sec and restarts the normal operation after the counter indicates 0. Moreover, when the voltage of the power source portion is equal to or lower than the level 2, it is displayed that the residual capacity level is equal to 3 by outputting five pulse signals at a short cycle and thereby quickly advancing the second hand by 5 sec as shown in FIG. 24(f). Thereafter, the counter subtracts the counter value 5 every second to stop movement for 5 sec and restarts the normal movement after the counter indicates 0.

It is also possible to change the above configuration for making the power-saving function prior to the time adjustment warning function information and charge warning function information to a digital configuration.

The configuration shown in FIG. 25 shows a timepiece constituted so as to perform digital display, which is provided with display means 500 having function display portions such as a second display portion 501, minute display portion 502, hour display portion 503, charge warning display portion 504, residual capacity display portion 505, and time adjustment warning display portion 506.

The oscillation circuit 48 and frequency dividing circuit 49 constituting reference signal generating means respectively output a reference signal. Pulse-signal forming means such as second pulse-signal forming means 301, minute pulse-signal forming means 302, and hour pulse-signal forming means 303 form a second pulse signal, minute pulse signal, and hour pulse signal in accordance with a reference signal and transmit the signals to controlling means 312. The controlling means 312 drives the second display portion 501, minute display portion 502, and hour display portion 503 of the display means 500 in accordance with the second pulse signal, minute pulse signal, and hour pulse signal.

Moreover, the controlling portion 312 connects with oscillation stop detecting means 322, switch operating means 323, voltage detecting means 321, charge warning means 324, and residual capacity warning means 325 in order to drive function display portions and moreover connects with power-saving state detecting means 326 in order to give priority to a power-saving state.

A time adjustment warning is displayed when the oscillation stop detecting means 322 detects oscillation stop and thereby, the controlling means 312 receives a signal from a latched circuit 311 latched in accordance with the detection signal and drives the time adjustment warning display portion 506. Moreover, when time adjustment is performed by the switch operating means 323, the latched circuit 311 is reset and the time adjustment warning display portion 506 cancels the display of the time adjustment warning. The charge warning is displayed on the charge warning display portion 504 when the charge warning means 324 compares the voltage of the power generating portion detected by the voltage detecting means 321 with a predetermined voltage and the voltage is lower than the predetermined voltage. In the case of the residual capacity warning, the residual capacity warning means 325 compares the voltage of the power-generating portion detected by the voltage detecting means 321 with a predetermined voltage to display a residual capacity on the residual capacity display portion 505 in accordance with the comparison result.

To make power saving prior to the above function information, the configuration shown in FIG. 25 is provided with the power-saving state detecting means 326 and controlling means 312. When receiving a signal showing a power-saving state from the power-saving state detecting means 326, the controlling means 312 makes a power-saving state prior to the function information on a time adjustment warning function, charge warning function, and residual capacity warning function and stops display these warnings when the means 312 is in the power-saving state.

Power-saving preferential operations by the above configuration are described below in accordance with the flowchart shown in FIG. 26.

When the above digital configuration is used and charge deficiency occurs, the controlling means 312 makes the charge warning means 504, residual capacity warning means 505, and time adjustment warning means 506 of the display means 500 display warnings in accordance with a detection signal of the voltage detecting means 321 or a detection signal of the oscillation stop detecting means 322.

When the electronic timepiece is restarted from each warning state by being recharged and time information is input, that is, a reference signal is input to the timepiece circuit portion 200 from the oscillation circuit 48 and frequency dividing circuit 49 (step W1), the controlling means 312 determines whether a time adjustment warning is initially output. This determination can be performed in accordance with a flag value set at the time of a time adjustment warning in the controlling means 312 (step W2). The controlling means 312 determines whether power is saved (step W3) when the time adjustment warning is output, determines that power is presently saved when a power-saving signal is output from the power-saving state detecting means 326, turns off the SET indication of the time adjustment warning means 506 showing a time adjustment warning (step W4), and then returns to step W1.

However, unless power is presently saved, the controlling means 312 turns on the SET indication to show the time adjustment warning (step W5).

When time adjustment is completed, the controlling means 312 determines whether a charge warning is output. This determination can be performed in accordance with a signal supplied from the charge warning means 324 receiving an output of the voltage detecting means 321 (step W6). When the charge warning is output, the controlling means 312 determines whether power is presently saved (step W7). When a power-saving signal is output from the power-saving state detecting means 326, the controlling means 312 determines that power is presently saved, turns off the indication of “CHARG” of the charge warning means 504 for showing a charge warning (step W8) and then returns to step W1. However, unless power is presently saved, the controlling means 312 turns on the indication of “CHARG” to show the charge warning (step W9).

When the charge warning is not output, the controlling means 312 determines whether power is presently saved (step W10). When a power-saving signal is output from the power-saving state detecting means 326, the means 312 determines that power is presently saved, turns off time indications 501 to 503 and a battery mark of the residual capacity warning means 505 (step W11), and then returns to step W1. However, unless power is presently saved, the controlling means 312 turns on the time indications 501 to 503 and the battery mark of the residual capacity warning means 505 to display time information and show a residual capacity warning (step W12).

Particularly, when power generating means uses a solar battery, it is very rational to give priority to a power-saving state to stop the display means as the power-saving state when detecting that the circumference of a timepiece gets dark because the above warning information cannot be seen in a state in which the circumference is dark and indications of the warning information are invisible. It is a matter of course that the same advantage can be obtained from even a power generating means other than a solar battery by using a sensor for detecting that the circumference of a timepiece is dark.

The configuration shown in FIG. 18 shows an example for making a power-saving state prior to the second hand rotating operation. However, the power-saving priority according to the present invention makes it possible to apply various power-saving preferential aspects to an hour hand, minute hand, second hand and day plate.

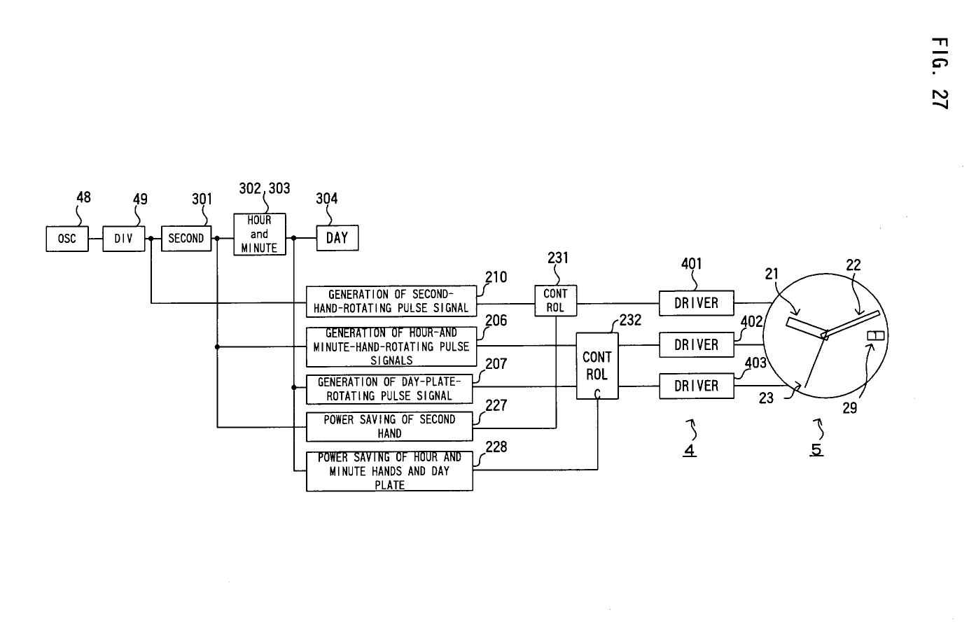

Various power-saving preferential aspects are described below by referring to FIGS. 27 to 29. In FIGS. 27 to 29, the description of a portion common to that of the configuration in FIG. 18 is omitted.

The power-saving preferential aspect shown in FIG. 27 uses a configuration of independently driving a second hand in accordance with a hand rotating pulse signal, driving an hour hand and minute hand in accordance with the same hand rotating pulse signal, and independently driving a day plate in accordance with a hand rotating pulse signal, in which the second hand is independently power-saving controlled and the hour hand, minute hand, and day plate are simultaneously power-saving controlled.

In FIG. 27, the second hand 23 is driven by the driver circuit 401 in accordance with a pulse signal supplied from second-hand rotating-pulse-signal forming means 210, an hour hand 21 and minute hand 22 are driven by the driver circuit 402 in accordance with a pulse signal supplied from the hour-and-minute hand rotating-pulse-signal forming means 206, and the day plate is driven by a driver circuit 403 in accordance with a pulse signal supplied from day-plate rotating-pulse signal forming means 207.

A power-saving function is executed by second-hand power-saving means 227 to the second hand 23 and hour-minute-day-plate power-saving means 228 to the hour hand 21, minute hand 22, and day plate. To give priority to a power-saving state in second movement, controlling means 231 is set between the second-hand rotating-pulse-signal forming means 210 and the driver circuit 401 to control the controlling means 231 so as to give priority to a power-saving state in second movement in accordance with a power-saving signal of the second-hand power-saving means 227. Moreover, to give priority to a power-saving state in an hour and minute movement and day-plate movement, controlling means 232 is set between the hour-and-minute hand rotating-pulse-signal forming means 206 and the day-plate rotating-pulse-signal forming means 207 and between the driver circuits 402 and 403 to control the controlling means 232 so as to give priority to the power-saving state in accordance with a power-saving signal of the hour-minute-day-plate power-saving means 228.

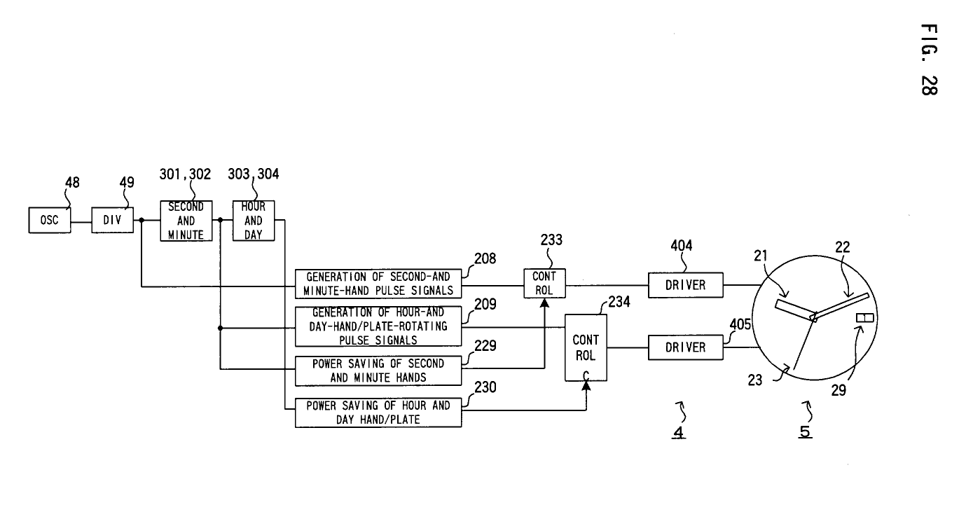

The power-saving preferential aspect shown in FIG. 28 uses a configuration of driving a second hand and a minute hand in accordance with the same hand rotating pulse signal and driving an hour hand and a day plate in accordance with the same hand rotating pulse signal, in which the second hand and minute hand are simultaneously power-saving controlled and the hour hand and day plate are simultaneously power-saving controlled.

In FIG. 28, the second hand 23 and minute hand 22 are driven by the driver circuit 404 in accordance with a pulse signal supplied from second-and-minute-hand rotating-pulse-signal forming means 208 and the hour hand 21 and day plate are driven by the driver 405 in accordance with a pulse signal supplied from hour and hour-and-day rotating-pulse-signal forming means 209.

The power-saving function is executed by second-and-minute hand power-saving means 229 to the second hand 23 and minute hand 22 and hour-minute-day-plate power-saving means 230 to the hour hand 21 and day plate. To give priority to a power-saving state in second- and minute movement, controlling means 233 is set between the second-and-minute-hand rotating-pulse-signal forming means 208 and the driver circuit 404 to control the controlling means 233 so as to give priority to the power-saving state in accordance with a power-saving signal of the second-and-minute hand power-saving means 229. Moreover, to give priority to a power-saving state in an hour hand and a day plate, controlling means 234 is set between the hour-and-day rotating-pulse-signal forming means 209 and the driver circuit 405 to control the controlling means 234 so as to give priority to the power-saving state in accordance with a power-saving signal of the hour-minute-day-plate power-saving means 230.

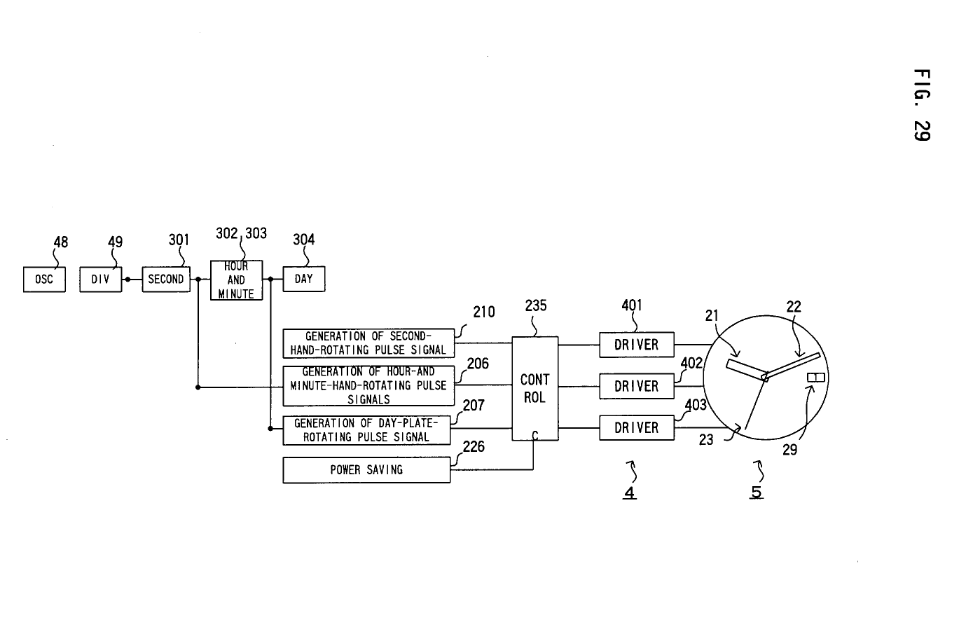

Moreover, the power-saving preferential aspect shown in FIG. 29 uses a configuration of independently driving the second hand 23 in accordance with a hand rotating pulse signal, driving the hour hand 21 and minute hand 22 in accordance with the same hand rotating pulse signal, and independently driving a day plate in accordance with a hand rotating pulse signal to display a day on a day indication 29, in which the second hand 23, minute hand 22, hour hand 21, and day plate are simultaneously power-saving controlled.

In FIG. 29, the second hand 23 is driven by the driver circuit 401 in accordance with a pulse signal supplied from the second-hand rotating-pulse-signal forming means 210, the hour hand 21 and-minute hand 22 are driven by the driver circuit 402 in accordance with a pulse signal supplied from the hour-and-minute hand rotating-pulse-signal forming means 206, and the day plate is driven by the driver circuit 403 in accordance with a pulse signal supplied from the day-plate rotating-pulse-signal forming means 207.

The power-saving means 226 simultaneously power-saving controls the second hand 23, minute hand 22, hour hand 21, and day plate, stops transmission of hand rotating pulse signals for the second hand 23, minute hand 22, hour hand 21, and day plate to the driver circuits 401 to 403, and perform control so as to give priority to a power-saving state. The day-plate rotating-pulse-signal forming means 207 can be provided with a perpetual calendar function for automatically performing date correction such as correction of a leap year or a calendar at the end of a month.

In this case, a function is used which communicates a power-saving state 1 by changing hand rotating modes of the minute hand 22 in the power-saving state 1 to the normal state when the second hand 23 is stopped in the power-saving state 1, the hour hand 21 and minute hand 22 are stopped in a power-saving state 2, and a day plate is stopped in a power-saving state 3.

Then, when a condition for starting the power-saving state 2 is satisfied, the fact that the power-saving state 22 is started due to stop of the minute hand 22 is made prior to the communicating function. Moreover, it is allowed to communicate the fact that the power-saving state 2 is started in the above mode by preparing the print of “PS2” on a day plate and using the indication of the “PS2”, and thereby display the power-saving state on a day window. Furthermore, it is allowed to continuously indicate days, that is, a calendar function. In the case of a calendar indication, when the condition of the power-saving 3 is satisfied, the power-saving state 3 is made prior to the perpetual calendar function. Moreover, an aspect is considered in which the hour hand 21, minute hand 22, and day plate are driven by the same motor and the same driver circuit. Also in this case, it is a matter of course that the same preferential control can be performed.

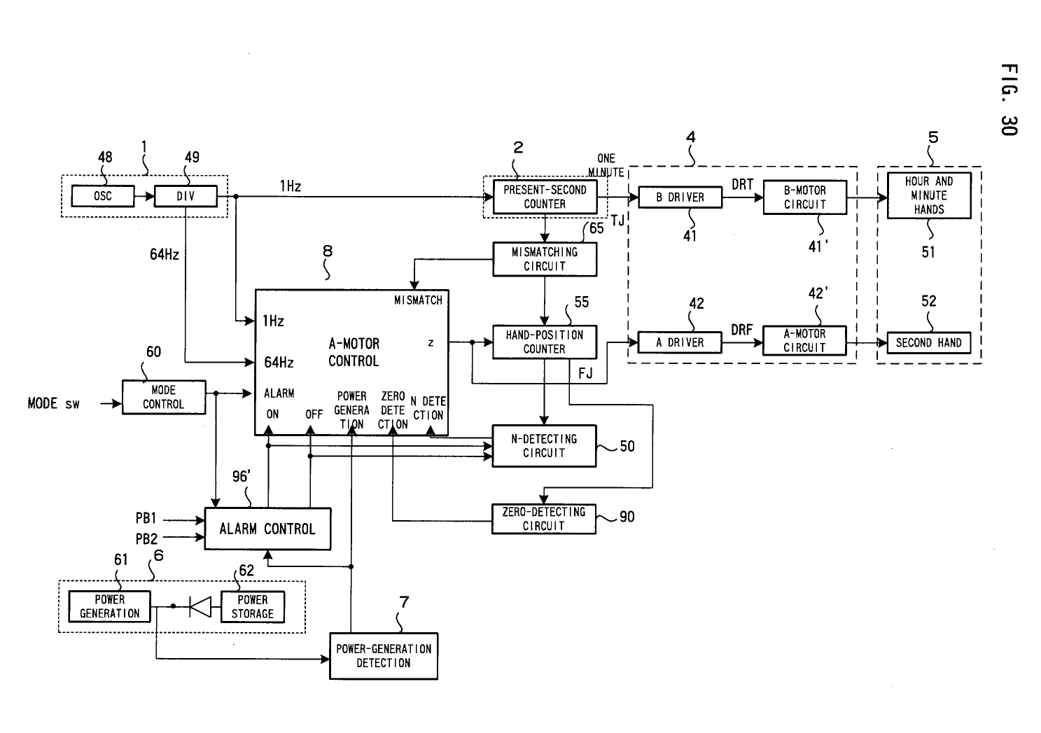

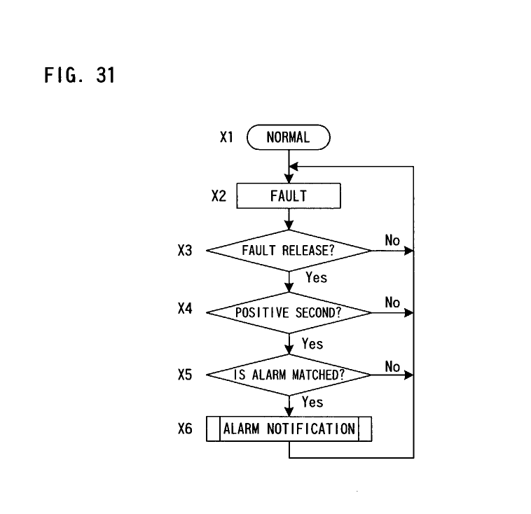

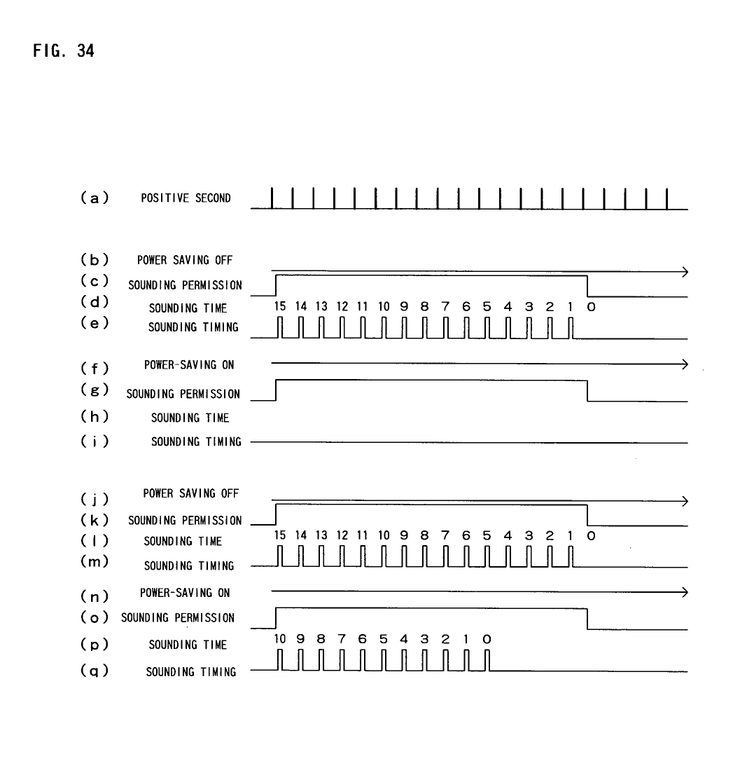

Furthermore, the power-saving preference of the present invention makes it possible to preferentially set the alarm function to a power-saving state. Then, configurations and operations for making a power-saving operation prior to an alarm function by referring to FIGS. 30 to 34. FIG. 30 is a schematic block diagram for explaining a configuration for making a power-saving operation prior to an alarm function, FIGS. 31, 32, and 33 are flowcharts for explaining operations for making a power-saving operation prior to an alarm function and FIG. 34 is timing chart for explaining operations for making an power-saving operation prior to an alarm function.

The configuration shown in FIG. 30 is almost the same as the configuration shown in FIG. 11. Therefore, a component same as that in FIG. 11 is provided with the same number and its description is omitted. The configuration shown in FIG. 30 is different from the configuration in FIG. 11 in that an output signal of power generating-detecting means 7 serving as means for detecting a power-saving operation state is input to alarm controlling means 96′ serving as one of function information generating means. This configuration makes it possible to give priority to a power-saving operation while an alarm function operates. The above control can be easily realized by using a CPU.

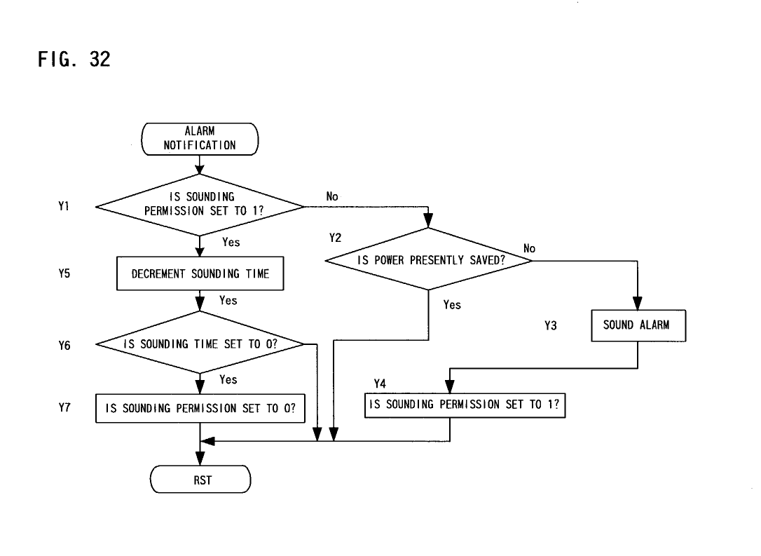

The above operation procedure is described below by referring to flowcharts in FIGS. 31 and 32. First, in the flowchart in FIG. 31, execution of normal control is designated (step X1) and thereafter a CPU is kept in a fault state (step X2). Thereafter, it is determined whether the fault state of the CPU is canceled (fault release) by the fact that a reference signal such as a 0.5 sec signal is generated (step X3).

In the determination process in step X3, when the fault state of the CPU is canceled, the process in step X2 is restarted and the above process is repeated. When the fault state of the CPU is not canceled, a positive second or not is determined. The above determination on the positive second or not can be executed by determining whether two 0.5 sec reference signals arrive (step X4).

Unless a positive second is not used in the determination process in step X4, the process in step X2 is restarted and the above process is repeated but when a positive second is used in the determination process in step X4, it is determined whether time information coincides with a predetermined alarm condition (step X5).

When time information does not coincide with a predetermined alarm condition in the determination process in step X5, the process in step X2 is restarted and the above process is repeated but when the time information coincides with the predetermined alarm condition, the subroutine shown in FIG. 32 relating to an alarm notification is executed.

In the subroutine shown in FIG. 32, it is first determined whether a sounding permission flag is set to 1 (step Y1). Because the sounding permission flag is set to 0 in the initial state, it is determined in step Y2 whether power is presently saved. When power is not presently saved in the determination process in step Y2, alarm sounding is started at the alarm sounding period (step Y3), the sounding permission flag is set to 1 (step Y4), and then step X2 is restarted.

However, when power is presently saved in the determination process in step Y2, step X2 is restarted while keeping the sounding permission flag at 0.

When the subroutine is executed at the next time and step Y3 is executed in the last time subroutine (step X6), the sounding permission flag is set to 1 in step Y3 and therefore, Yes is set in the determination process in step Y1 and step Y5 is restarted.

After decrementing a sounding period in step Y5 in accordance with the sounding period set in step Y3, it is determined whether the sounding period is set to 0 (step Y6). When the sounding period is not set to 0 in the determination process in step Y6, the subroutine is repeated and decrementing the sounding period in step Y5 and the determination process in step Y6 are repeated and when it is determined that the sounding period is set to 0, the sounding permission flag is reset to 0 to return to the main flowchart (step Y7).

Timing charts shown in FIGS. 34(a)-34(i) show a case in which a clock to be generated is assumed as a positive second (1 sec) (FIG. 34(a)) and a sounding period to be set in accordance with a sounding permission signal is set to 15 sec. FIGS. 34(b)-34(e) show a power-saving state signal, sounding permission signal, sounding period, and sounding timing respectively while power is not presently saved and show that an alarm sounds for 15 sec after the sounding permission signal rises. FIGS. 34(f)-34(i) show a power-saving state signal, sounding permission signal, sounding period, and sounding timing respectively while power is presently saved and show that an alarm does not sound even if the sounding permission signal rises.

Moreover, the power-saving preference according to the present invention makes it possible to realize an aspect for making power saving prior to functions by an aspect for restricting function operations in a power-saving state.

The restriction of function operations sets a function operation period of function information generating means so that it becomes shorter than the normal function operation period when the power-saving state starts under function operation. For example, the driving period of the function information generating means is restricted in a power-saving state by setting a chronographic function display period to a period shorter than the normal period when function information generating means has a chronographic function or setting an alarm sounding period to a period shorter than the normal period when the function information generating means has an alarm function.

The function operation-restricting configuration can be realized by inputting an output signal of the charger-detecting means 7 serving as means for detecting a power-saving operation state to the chronographic controlling means 96 in the configuration in FIG. 7 when function information generating means has a chronographic function and moreover, it is possible to use the configuration in FIG. 30 when the function information generating means has an alarm function.

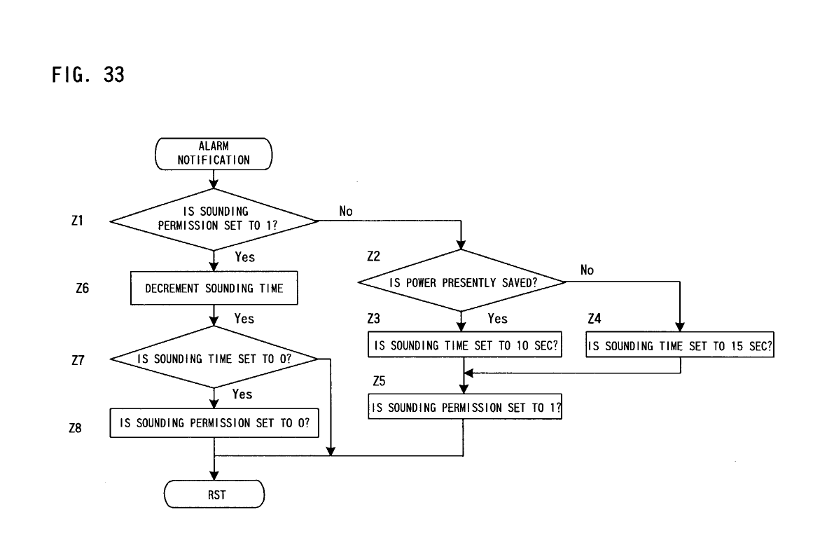

Operations when the function information generating means has an alarm function are described below by referring to the flowchart in FIG. 33 and the timing charts in FIG. 34(FIGS. 34(a), (j)-(q)). Because the main flowchart shown in FIG. 31 is common to the last time, the flowchart in FIG. 33 is descried below.

In the subroutine shown in FIG. 33, it is first determined whether a sounding permission flag is set to 1 (step Z1). Because the sounding permission flag is set to 0 in the initial state, it is determined in step Z2 whether power is presently saved. When power is not presently saved in the determination process in step Z2, a sounding period is set to the normal sounding period (e.g. 15 sec), alarm sounding is started (step Z4), the sounding permission flag is set to 1 (step Z5), and then step X5 is restarted.

However, when power is presently saved in the determination process in step Z2, a sounding period is set to a period shorter than the normal sounding period (e.g. 10 sec) to start alarm sounding (step Z3), the sounding permission flag is set to 1 (step Z5), and then step X5 is restarted.

When the above subroutine is executed at the next time, the sounding permission flag is set to 1 in step Z5 of the last-time subroutine (step X6). Therefore, Yes is set in the determination process in step Z1 and step Z6 is started.

In step Z6, a sounding period is decremented in accordance with the sounding period set in step Z3 or Z4 and then it is determined whether the sounding period is set to 0 (step Z7). When the sounding period is not set to 0 in the determination process instep Z7, this subroutine is repeated, decrementing of the sounding period in step Z6 and the determination process in step Z7 are repeated, the sounding permission flag is reset to 0 when it is determined that the sounding period is set to 0, and the main flowchart is restarted (step Z8).

Timing charts shown in FIG. 34(a) and FIGS. 34(j)-34(q) show a case of assuming a generated clock as a positive second (1 sec) (FIG. 34(a)), setting a sounding period set in accordance with a sounding permission signal to 15 sec in the normal state, and restricting and setting the sounding period to 10 sec in a power-saving state. FIGS. 34(j)-34(m) show a power-saving state signal, sounding permission signal, sounding period, and sounding timing respectively while power is not presently saved and show that an alarm sounds for 15 sec after the sounding permission signal rises. FIGS. 34(n) to 34(q) show a power-saving state signal, sounding permission signal, sounding-period, and sounding timing respectively while power is not presently saved and show that an alarm sounds for 10 sec after the sounding permission signal rises.

Moreover, the power-saving preference according to the present invention can be realized in an aspect for making power saving prior to a time correcting function also in the case of a radio wave correcting timepiece having a power generating function and using a standard time radio wave for time correction.

Some of power-saving functions to be normally executed by a radio wave correcting timepiece having a power generating function maximally lengthen the timepiece operating period at the time of display power generation or when they are not executed by stopping display time or various functions when a state in which power is not generated continues for a certain period or more. In this power-saving operation, to automatically receive the standard time radio wave at the specified time once a day by the radio wave correcting function similarly to the normal state, the power consumption for receiving the radio wave increases as a load under a power-saving state to shorten a timepiece-operation period.

Therefore, by controlling the power consumption of receiving means for receiving the standard time radio wave in accordance with a power-generating state in a radio wave correcting timepiece having a power generating function, a power-saving state is made prior to radio wave correction to improve the power-saving effect.

An aspect for controlling the power consumption of receiving means may take a first aspect for restricting a receiving function by stopping the function of the receiving means when the voltage of power generating means is equal to or less than a predetermined value or lengthening a cycle for the receiving means to receive the standard time radio wave, and a second aspect for restricting the receiving function in accordance with the standard time radio wave receiving state of the receiving means.

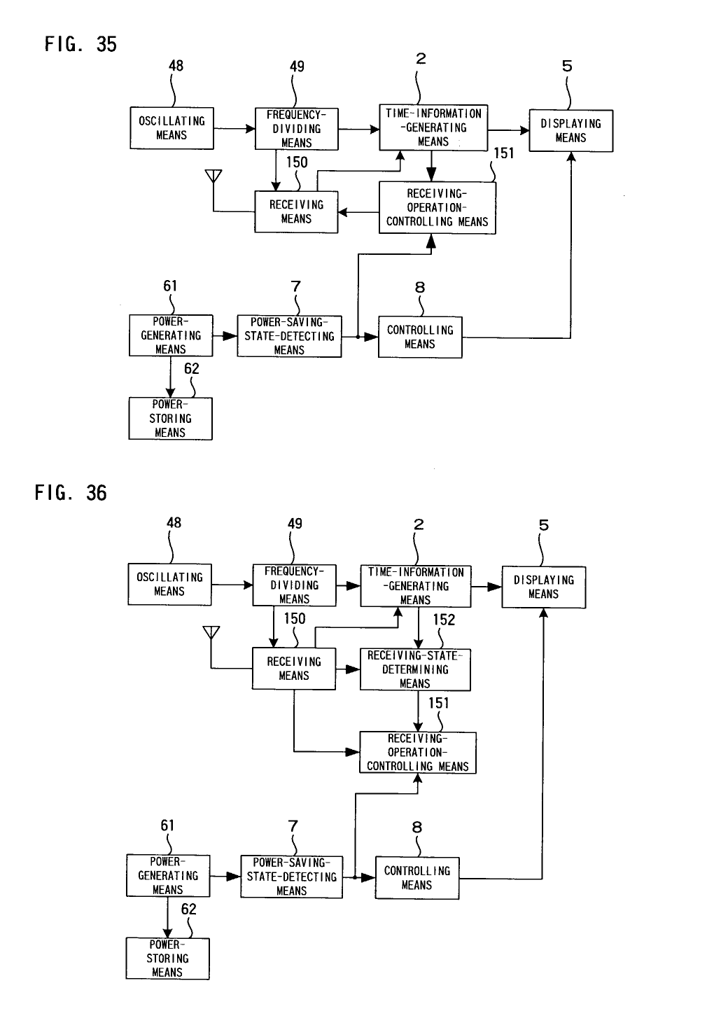

The first and second aspects in described below by referring to FIGS. 35 and 36.

First, the first aspect is described below. FIG. 35 is a schematic block diagram for explaining the first aspect of a radio wave correcting timepiece having a power generating function. In FIG. 35, symbol 61 denotes power generating means for generating power in accordance with the energy supplied from an external unit and 62 denotes power-storing means including a secondary battery serving as a power source of every circuit. Oscillating means 48, frequency diving means 49, and time information generating means 2 constitute a timepiece circuit to display time by time display means 5 in accordance with a timepiece signal of the time information generating means 2. Symbol 150 denotes receiving means including an antenna to receive the standard time radio wave. The time information generating means 2 corrects time in accordance with the received standard time radio wave. Moreover, the power-saving state detecting means 7 detects a power-saving state from a power generating state in accordance with a voltage generated by the power generating means 61. The controlling means 8 power-saving controls the time indication of the display means 5 in accordance with an output of the power-saving state detecting means 7. Moreover, receiving operation controlling means 151 receives a signal from the time information generating mans 2 and a power generating state signal from the power-saving state detecting means 7 to control receiving means 150.

The power-saving operation of the first aspect can be performed as described below.

When the power generating means 61 presently generates power, the controlling means 8 receives a “H” level signal from the power-saving state detecting means 7 and transmits a time display controlling signal to the display means 5 to make the means 5 perform normal time display. Moreover, the receiving operation controlling means 151 controls the receiving means 150 so as to automatically receive the standard time radio wave at a specified time in accordance with a timepiece signal supplied from the time information generating means 2 once a day when the power generating state signal of the power-generating state detecting means 7 is a “H” level signal. The received time information is output to the time information generating means 2 and the means 2 is corrected to an accurate time. The display means 5 displays time in accordance with a timepiece signal of the time information generating means 2.

However, when the power generating means 1 does not generate power, an “L” level power generating state signal is output from the power-saving state detecting means 7. When the signal is continuously output for a certain period, a power-saving state is set and the controlling means 8 outputs an “L” level time display controlling signal to the display means 5.

Moreover, the receiving operation controlling means 151 does not perform reception every time even if a specified time according to a timepiece signal supplied from the time information generating means 2 elapses when a power-generating state signal is kept at “L” level but the means 151 performs control by lengthening a control cycle so that the receiving means 150 operates once for ten days, for example. The received time information is output to the time information generating means 2. However, when display is stopped by the controlling means 8, time is not displayed by the time information generating means 2 but display stop is continued.

Then, the second aspect is described below. FIG. 36 is a schematic block diagram for explaining the second aspect of a radio wave correcting timepiece having a power generating function. The configuration shown in FIG. 36 is almost the same as the configuration shown in FIG. 35 except receiving state determining means 152. Therefore, description of common components is omitted.

The receiving state determining means 152 determines a receiving state in accordance with a standard time radio wave receiving output of the receiving means 150 and transmits the receiving state to the receiving operation controlling means 151. The receiving operation controlling means 151 controls the receiving operation of the receiving means 150 in accordance with the receiving state.

It is possible to perform the power-saving operation of the second aspect as described below.

While the power generating means 61 presently generates power, time is displayed the same as the first aspect does. However, while the power generating means 1 does not presently generate power, the same control as the case of the first aspect is performed and the receiving operation is controlled by the receiving state determining means 152. When a receiving state of the receiving means 150 is preferable, the receiving state determining means 152 controls the receiving operation controlling means 151 so as to perform the normal power-saving operation. However, when the receiving state of the receiving means 150 is not preferable because the receiving output of a receiving radio wave is deteriorated, the receiving state determining means 152 controls the receiving operation controlling means 151 so as to restrict the receiving operation of the means 150. Restriction of the receiving operation makes it possible to stop reception or change a receiving cycle so as to lengthen a receiving interval and set the receiving cycle in accordance with the degree of a receiving state. It is also possible to change receiving cycles in accordance with the next time receiving state determination result.

Moreover, the power-saving preference of the present invention makes it possible to realize an aspect of making a power-saving state prior to a function state in accordance with two stages such as a first stage power-saving state for saving power in accordance with a hand rotating aspect of making hand rotating intervals of an hour hand, minute hand, and second hand different from the normal hand rotating interval and a second-stage power-saving state for stopping rotations of an hour hand, minute hand, and second hand.

An electronic timepiece and an electronic timepiece driving method of the present invention use the above technical configurations. Therefore, it is possible to easily realize a multifunction electronic timepiece having a high commercial value and capable of providing various types of additional function information constituted so as to be able to separately use a power-saving mode and a function information operation state mode and an electronic timepiece driving method, and perform the control for making the power-saving mode prior to the function information operation state mode.

1. An electronic timepiece comprising:
time information generating means for generating time information;
function information generating means for generating function information;
display means for making it possible to selectively display the time information and/or the function information;
power-saving operation means for performing operations in a power-saving operation state consuming a power less than the normal operation state; and
power-saving operation preferential means for making the power-saving operation of the power-saving operation means prior to a function information operation.

2. An electronic timepiece comprising: reference signal generating means; time information generating means for generating time information in accordance with a reference signal supplied from the reference signal generating means; function information generating means for generating function information; display drive means for outputting a driving signal for display the function information and time information; and display means for display the function information and the time information in accordance with a driving signal supplied from the display drive means; and having a power-saving operation state consuming a power less than the normal operation state,
wherein the power-saving operation state is made prior to the function operation state of the function information generating means.

3. An electronic timepiece comprising: reference signal generating means; time information generating means for generating time information in accordance with a reference signal supplied from the reference signal generating means; function information generating means for generating function information; display drive means for outputting a driving signal for display the function information and time information; and display means for display the function information and the time information in accordance with a driving signal supplied from the display drive means; and having a power-saving operation state consuming a power less than the normal operation state,
wherein function information generated by the function information generating means under the power-saving operation state is disabled.

4. An electronic timepiece comprising: reference signal generating means; time information generating means for generating time information in accordance with a reference signal supplied from the reference signal generating means; function information generating means for generating function information; display drive means for outputting a driving signal for display the function information and time information; and display means for display the function information and the time information in accordance with a driving signal supplied from the display drive means; and having a power-saving operation state consuming a power less than the normal operation state,
wherein operation command disabling means for disabling an operation command for commanding the function information generating means to start operations is included, and
the operation command disabling means maintains a power-saving operation by disabling an operation command generated under a power-saving operation state.

5. An electronic timepiece comprising: reference signal generating means; time information generating means for generating time information in accordance with a reference signal supplied from the reference signal generating means; function information generating means for generating function information; display drive means for outputting a driving signal for display the function information and time information; and display means for display the function information and the time information in accordance with a driving signal supplied from the display drive means; and having a power-saving operation state consuming a power less than the normal operation state,
wherein when a condition for satisfying a power-saving operation state is satisfied while the function information generating means operates, the power-saving operation state is set instead of the operation state of the function information generating means, to stop the operation of function information.

6. The electronic timepiece according to any one of claims 1 to 5, wherein predetermined means to be set to a power-saving state under a power-saving operation state and predetermined means to be operated when the function information generating means becomes a function operation state are constituted so as to partly overlap with each other.

7. The electronic timepiece according to any one of claims 1 to 6, wherein all of predetermined means to be set to a power-saving state under a power-saving operation state are set to the power-saving operation state when the function information generating means becomes a function operation state.

8. The electronic timepiece according to claim 5, wherein function information generated by function information generating means is stored under the power-saving operation state.

9. The electronic timepiece according to claim 3, wherein function information generated by function information generating means is stored under the power-saving operation state.

10. An electronic timepiece comprising: reference signal generating means; time information generating means for generating time information in accordance with a reference signal supplied from the reference signal generating means; function information generating means for generating function information; display drive means for outputting a driving signal for display the function information and time information; and display means for display function information and display means for display time information in accordance with a driving signal supplied from the display drive means; and further comprising power-saving operation detecting means for detecting presence or absence of a state requiring a power-saving operation and controlling means capable of controlling each of the display drive means to any one of the normal operation state, a power-saving operation state consuming a power less than the normal operation state, and function operation state,
wherein the controlling means is constituted so as to set some or all of display means to a power-saving operation state in response to a detection signal of power-saving operation state detecting means, set some or all of function information generating means to a function operation state in response to a detecting signal of function operation state detecting means, and make power-saving operation states of display means prior to function operation states of at least some of display means when a power-saving operation state detecting signal competes with a function operation state detecting signal.

11. The electronic timepiece according to claim 10, wherein the controlling means is constituted so as to set display means to a power-saving operation state or a function operation state in response to a detection signal of function operation state detecting means or a detection signal of power-saving operation state detecting means when at least some of time information display means is kept in the normal state, and give priority to a detection signal supplied from power-saving operation state detecting means when the display means is kept in a function operation state, and a detection signal supplied from the power-saving operation state detecting means is detected.

12. The electronic timepiece according to claim 7, wherein the controlling means is constituted so as to set display means to a power-saving operation state or a function operation state in response to a detection signal of function operation state detecting means or a detection signal of power-saving operation state detecting means when at least some of display means is kept in the normal state, cancel a detection signal output from function operation state detecting means when display means is kept in a power-saving operation state, and maintain a power-saving operation state.

13. The electronic timepiece according to any one of claims 1 to 12, wherein at least some of the display means is constituted by a digital display system or analog display system.

14. The electronic timepiece according to any one of claims 1 to 13, wherein a power source for driving each means of the electronic timepiece uses one of power generating means such as a primary battery, solar battery, hand-winding generator, self-winding generator, and temperature-difference generator, and a combination of the secondary battery or a capacitor with the power generating means.

15. The electronic timepiece according to any one of claims 1 to 14, wherein a pressure sensor is further included and the function information generating means is constituted so as to be able to measure altitude measuring function information or depth measuring function information in accordance with the sense information supplied from the pressure sensor.

16. The electronic timepiece according to any one of claims 1 to 14, wherein a temperature sensor is further included and the function information generating means is constituted so as to be able to measure temperature function information or water-temperature function information in accordance with the sense information supplied from the temperature sensor.

17. The electronic timepiece according to any one of claims 1 to 16, wherein delaying means is further included which shifts the normal operation state to a power-saving operation state after a condition for starting the power-saving operation state is satisfied and a predetermined delay time elapses.

18. The electronic timepiece according to any one of claims 1 to 17, wherein the power-saving operation state stops some of circuit means of an integrated circuit for driving the electronic timepiece.

19. The electronic timepiece according to any one of claims 1 to 17, wherein the power-saving operation state stops some of the display means.

20. The electronic timepiece according to claim 19, wherein some of the display means are second hands.

21. The electronic timepiece according to any one of claims 1 to 20, wherein power generating means and power-storing means to which the electric energy supplied from the power generating means is charged are further included.

22. The electronic timepiece according to claim 21, wherein operations are performed by the power-storing means.

23. The electronic timepiece-according to any one of claims 7, 8, and 12, wherein the power-saving operation state detecting means is constituted by a mechanism for automatically detecting any one of the power generating state of power generating means, the output voltage or output current of a primary battery or secondary battery, and the illuminance of the light to the electronic timepiece, or a setting mechanism according to manual operations.

24. An electronic timepiece driving method for an electronic timepiece having a power-saving operation state consuming a power less than the normal operation state and making it possible to selectively display time information and/or function information, wherein the power-saving operation is made prior to the operation of function information.

25. An electronic timepiece driving method for an electronic timepiece comprising reference signal generating means, time information generating means for generating time information in accordance with a reference signal supplied from the reference signal generating means, function information generating means for generating function information, display drive means for outputting a driving signal for display the function information and time information, and display means for display the function information and the time information in accordance with a driving signal supplied from the display drive means, and having a power-saving operation state consuming a power less than the normal operation state,
wherein the power-saving-operation state is made prior to the function operation state of the function information generating means.

26. An electronic timepiece driving method for an electronic timepiece comprising reference signal generating means, time information generating means for generating time information in accordance with a reference signal supplied from the reference signal generating means, function information generating means for generating function information, display drive means for outputting a driving signal for display the function information and time information, and display means for display the function information and the time information in accordance with a driving signal supplied from the display drive means, and having a power-saving operation state consuming a power less than the normal operation state,
wherein when the function information generating means starts operations under a power-saving operation state, the operation of the function information is controlled to be disabled.

27. An electronic timepiece driving method for an electronic timepiece comprising reference signal generating means, time information generating means for generating time information in accordance with a reference signal supplied from the reference signal generating means, function information generating means for generating function information, display drive means for outputting a driving signal for display the function information and time information, and display means for display the function information and the time information in accordance with a driving signal supplied from the display drive means, and having a power-saving operation state consuming a power less than the normal operation state,
wherein a power-saving operation is controlled to be maintained by disabling an operation command generated under a power-saving operation state to command the function information generating means to start operations.

28. An electronic timepiece driving method for an electronic timepiece comprising reference signal generating means, time information generating means for generating time information in accordance with a reference signal supplied from the reference signal generating means, function information generating means for generating function information, display drive means for outputting a driving signal for display the function information and time information, and display means for display the function information and the time information in accordance with a driving signal supplied from the display drive means, and having a power-saving operation state consuming a power less than the normal operation state,
wherein when a condition for satisfying a power-saving operation state is satisfied while the function information generating means operates, the power-saving operation is set instead of the operation state of the function information generating means, to stop the operation of function information.

29. The electronic timepiece driving method according to any one of claims 24 to 28, wherein power generating means and power-storing means to be charged by the power generating means are further included and when it is determined that either of an output voltage and output current of the power-storing means or power generating means is insufficient to operate the function information generating means, display by the display means is constituted to be stopped.
